(19) United States
(12) Patent Application Publication
(10) Pub. No.: US 2023/0064359 A1
(43) Pub. Date: Mar. 2, 2023

(54) ELECTRONIC CONTROL DEVICE

(71) Applicant: DENSO CORPORATION, Kariya-city (JP)

(72) Inventors: Shozen KUDO, Kariya-city (JP); Hitoshi YUMOTO, Kariya-city (JP); Takayuki TSUKAMIZU, Kariya-city (JP); Shunji YAMAUCHI, Kariya-city (JP); Tatsuzou SUZUKI, Obu-city (JP)

(21) Appl. No.: 17/878,109

(22) Filed: Aug. 1, 2022

(30) Foreign Application Priority Data
Aug. 30, 2021 (JP) 2021-140124

(51) Int. Cl. H01F 7/06; G07C 5/08; B60R 16/033

(52) U.S. Cl. CPC H01F 7/064; G07C 5/0808; B60R 16/033

(57) ABSTRACT

An electronic control device is configured to control at least one electromagnetic valve mounted on a vehicle. The electronic control device includes a regenerative current detector configured to detect a regenerative current circulating through the at least one electromagnetic valve immediately after power supply to the at least one electromagnetic valve is stopped. The electronic control device further includes a regenerative current singularity detector configured to detect a regenerative current singularity that is a singularity in a temporal change of the regenerative current. The electronic control device further includes a regenerative current failure detector configured to detect a stuck failure of the at least one electromagnetic valve based on a detection result of the regenerative current singularity detector.

### CROSS REFERENCE TO RELATED APPLICATION

The present application claims the benefit of priority from Japanese Patent Application No. 2021-140124 filed on Aug. 30, 2021. The entire disclosures of all of the above applications are incorporated herein by reference.

### TECHNICAL FIELD

The present disclosure relates to an electronic control device that controls an electromagnetic valve.

### BACKGROUND

There is an electromagnetic valve control unit that controls an electromagnetic valve current flowing through an electromagnetic valve when the electromagnetic valve is driven.

### SUMMARY

According to an aspect of the present disclosure, an electronic control device is configured to control at least one electromagnetic valve mounted on a vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of an ECU and an electromagnetic valve according to first, second, and third embodiments;

FIG. 2 is timing charts for describing erroneous determination;

FIG. 3 is a flowchart illustrating failure determination processing according to the first embodiment;

FIG. 4 is a timing chart illustrating temporal changes of a power supply voltage, an electromagnetic valve voltage, and an electromagnetic valve current according to the first embodiment;

FIG. 5 is a flowchart illustrating failure determination processing according to the second embodiment;

FIG. 6 is a timing chart illustrating temporal changes of a power supply voltage, an electromagnetic valve voltage, and an electromagnetic valve current according to the second embodiment;

FIG. 7 is a flowchart illustrating failure determination processing according to the third embodiment;

FIG. 8 is a timing chart illustrating temporal changes of a power supply voltage, an electromagnetic valve voltage, and an electromagnetic valve current according to the third embodiment;

FIG. 9 is a diagram illustrating a configuration of an ECU and an electromagnetic valve according to a fourth embodiment;

FIG. 10 is a flowchart illustrating regenerative current failure determination processing;

FIG. 11 is a timing chart illustrating temporal changes of a power supply voltage, an electromagnetic valve voltage, and an electromagnetic valve current according to the fourth embodiment;

FIG. 12 is a diagram illustrating a configuration of an ECU to which a Zener diode is connected;

FIG. 13 is a timing chart illustrating temporal changes of a negative terminal voltage and an electromagnetic valve current;

FIG. 14 is a timing chart illustrating a temporal change of an electromagnetic valve current in a state where the electromagnetic valve is switched from an on state to an off state;

FIG. 15 is a diagram illustrating a configuration of an ECU and an electromagnetic valve according to a fifth embodiment;

FIG. 16 is a flowchart illustrating failure determination processing according to the fifth embodiment;

FIG. 17 is a diagram illustrating a configuration of an ECU and an electromagnetic valve according to a sixth embodiment;

FIG. 18 is a diagram illustrating a configuration of an ECU and an electromagnetic valve according to a seventh embodiment;

FIG. 19 is a timing chart illustrating temporal changes of an electromagnetic valve voltage and a detected current according to the seventh embodiment;

FIG. 20 is a diagram illustrating a configuration of an ECU and an electromagnetic valve according to an eighth embodiment;

FIG. 21 is a table for describing a failure in the eighth embodiment;

FIG. 22 is a flowchart illustrating terminal failure detection processing according to the eighth embodiment;

FIG. 23 is a diagram illustrating a configuration of an ECU and an electromagnetic valve according to a ninth embodiment;

FIG. 24 is a table for describing a failure in the ninth embodiment; and

FIG. 25 is a flowchart illustrating terminal failure detection processing according to the ninth embodiment.

### DETAILED DESCRIPTION

Examples of the present disclosure will be described below.

According to an example of the present disclosure, an electromagnetic valve control unit is assumable. This electromagnetic valve control unit detects a stuck failure of an electromagnetic valve in accordance with presence or absence of a singularity at a time of rising of an electromagnetic valve current flowing through the electromagnetic valve when the electromagnetic valve is driven.

As a result of detailed studies by the inventor(s), an issue has been found. Specifically, a failed electromagnetic valve is erroneously determined to be normal due to a rapid voltage fluctuation in a direct-current power supply, which applies a power supply voltage to the electromagnetic valve.

According to an example of the present disclosure, an electronic control device is configured to control at least one electromagnetic valve mounted on a vehicle.

The electronic control device comprises a regenerative current detector configured to detect a regenerative current circulating through the at least one electromagnetic valve immediately after power supply to the at least one electromagnetic valve is stopped.

The electronic control device further comprises a regenerative current singularity detector configured to detect a regenerative current singularity that is a singularity in a temporal change of the regenerative current. The electronic control device further comprises a regenerative current failure detector configured to detect a stuck failure of the at least one electromagnetic valve based on a detection result of the regenerative current singularity detector,

This electronic control device of the present disclosure configured as described above detects a regenerative current singularity of a regenerative current that is not affected by the voltage fluctuation in the direct-current power supply. Thus, this electronic control device of the present disclosure enables to suppress occurrence of a situation in which the failed electromagnetic valve is erroneously determined to be normal due to a voltage fluctuation in the direct-current power supply. Thus, the electronic control device enables to improve detection accuracy of an electromagnetic valve failure.

According to another example of the present disclosure, an electronic control device is configured to control at least one electromagnetic valve mounted on a vehicle.

The electronic control device comprises an electromagnetic valve current detector configured to detect an electromagnetic valve current flowing through the at least one electromagnetic valve after power supply to the at least one electromagnetic valve is started.

The electronic control device further comprises a power supply voltage detector configured to detect a power supply voltage of a direct-current power supply that is configured to apply the power supply voltage to the at least one electromagnetic valve.

The electronic control device further comprises an electromagnetic valve current singularity detector configured to detect an electromagnetic valve current singularity that is a singularity in a temporal change of the electromagnetic valve current.

The electronic control device further comprises an electromagnetic valve current failure detector configured to detect a stuck failure of the at least one electromagnetic valve based on a detection result of the electromagnetic valve current singularity detector.

The electronic control device further comprises a failure detection inhibitor configured to determine whether a fluctuation in the power supply voltage has occurred based on a detection result of the power supply voltage detector and, on determination that the fluctuation in the power supply voltage has occurred, inhibit the electromagnetic valve current failure detector from detecting the stuck failure until a preset inhibition release condition is satisfied.

This electronic control device of the present disclosure configured as described above inhibits detection of a stuck failure when a fluctuation in the power supply voltage occurs. Thus, the electronic control device of the present disclosure enables to suppress occurrence of a situation in which the failed electromagnetic valve is erroneously determined to be normal due to a voltage fluctuation in the direct-current power supply, and enables to improve detection accuracy of an electromagnetic valve failure.

According to another example of the present disclosure, an electronic control device is configured to control at least one electromagnetic valve mounted on a vehicle.

The electronic control device comprises an electromagnetic valve current detector and a power supply voltage detector.

The electronic control device further comprises an electromagnetic valve current singularity detector configured to detect an electromagnetic valve current singularity that is a singularity in a temporal change of the electromagnetic valve current.

The electronic control device further comprises an electromagnetic valve current failure detector configured to detect a stuck failure of the at least one electromagnetic valve based on a detection result of the electromagnetic valve current singularity detector.

The electronic control device further comprises an invalidator configured to determine whether a fluctuation in the power supply voltage has occurred based on a detection result of the power supply voltage detector and, on determination that the fluctuation in the power supply voltage has occurred, invalidate at least a detection result of the electromagnetic valve current singularity detector corresponding to a time point at which the fluctuation in the power supply voltage occurs.

The electronic control device of the present disclosure configured as described above invalidates a detection result of an electromagnetic valve current singularity detector when a fluctuation in the power supply voltage occurs. Thus, the electronic control device of the present disclosure enables to suppress occurrence of a situation in which the failed electromagnetic valve is erroneously determined to be normal due to a voltage fluctuation in the direct-current power supply, and enables to improve detection accuracy of an electromagnetic valve failure.

### First Embodiment

Hereinafter, a first embodiment of the present disclosure will be described with reference to the drawings.

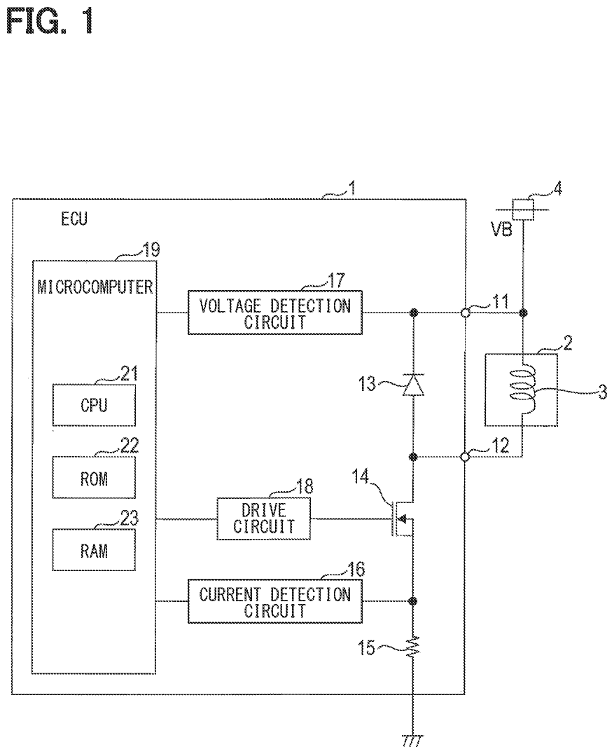

An electronic control unit 1 (hereinafter, ECU 1) according to the present embodiment is mounted on a vehicle and controls an electromagnetic valve 2 as illustrated in FIG. 1. The ECU is an abbreviation for an electronic control unit.

The electromagnetic valve 2 includes a solenoid coil 3 and a movable core (not illustrated). A first end of the solenoid coil 3 is connected to a positive electrode of a vehicle power supply 4, and a second end of the solenoid coil 3 is grounded.

In a non-energized state in which no current is flowing through the solenoid coil 3, the electromagnetic valve 2 according to the present embodiment is in a closed valve state in which the valve is closed. On the other hand, when the electromagnetic valve 2 according to the present embodiment is in an energized state in which a current flows through the solenoid coil 3, a magnetic attraction force for attracting the movable core is generated, the movable core thus moves, and the electromagnetic valve 2 enters an open valve state in which the valve is opened. The electromagnetic valve 2 may be configured to be in the open valve state in the non-energized state and to be in the closed valve state in the energized state.

Hereinafter, a state in which a current is flowing through the solenoid coil 3 in the electromagnetic valve 2 is referred to as a valve energized state, and a state in which no current is flowing through the solenoid coil 3 in the electromagnetic valve 2 is referred to as a valve non-energized state.

The ECU 1 includes a positive terminal 11, a negative terminal 12, a diode 13, a switching element 14, a shunt resistor 15, a current detection circuit 16, a voltage detection circuit 17, a drive circuit 18, and a microcomputer 19.

The positive terminal 11 is connected to the first end of the solenoid coil 3. The negative terminal 12 is connected to the second end of the solenoid coil 3.

The diode 13 has an anode connected to the negative terminal 12 and a cathode connected to the positive terminal 11.

The switching element 14 is a transistor provided on an energization path from the solenoid coil 3 to a ground. When the switching element 14 is in an on state, a current flows through the energization path, and when the switching element 14 is in an off state, no current flows through the energization path. Hereinafter, “the switching element 14 is in the on state” is also referred to as “the electromagnetic valve 2 is in the on state”, and “the switching element 14 is in the off state” is also referred to as “the electromagnetic valve 2 is in the off state”.

The switching element 14 has a first end connected to the negative terminal 12, and the switching element 14 has a second end connected to a first end of the shunt resistor 15. Then, a second end of the shunt resistor 15 is grounded.

The current detection circuit 16 detects a voltage across both ends of the shunt resistor 15 and detects a current (hereinafter, the electromagnetic valve current) flowing through the electromagnetic valve 2 on the basis of the voltage value. Then, the current detection circuit 16 outputs a current detection signal indicating a detection result of the electromagnetic valve current to the microcomputer 19.

The voltage detection circuit 17 detects a voltage at the positive terminal 11 and outputs a voltage detection signal indicating the detection result to the microcomputer 19.

The drive circuit 18 outputs, to the switching element 14, a drive signal for driving the switching element 14 such that the switching element 14 is in the on state or the off state on the basis of a control signal output from the microcomputer 19.

The microcomputer 19 includes a CPU 21, a ROM 22, and a RAM 23.

Various functions of the microcomputer 19 are implemented by the CPU 21 executing a program stored in a non-transitory tangible storage medium. In this example, the ROM 22 corresponds to a non-transitory tangible storage medium storing a program. By executing the program, a method corresponding to the program is executed. A part or all of the functions executed by the CPU 21 may be configured as hardware by one or a plurality of ICs or the like.

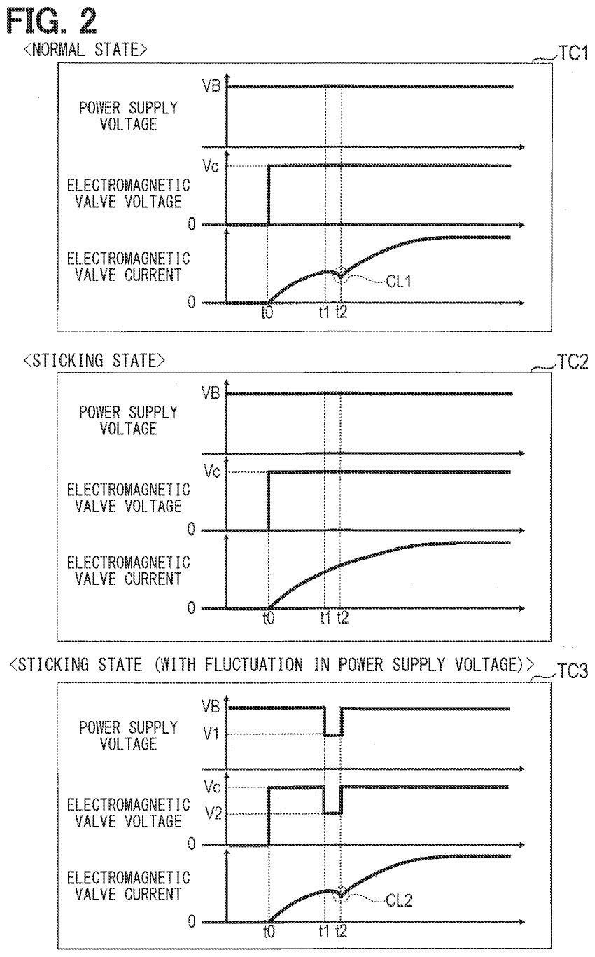

A timing chart TC1 in FIG. 2 illustrates temporal changes of the power supply voltage, the electromagnetic valve voltage, and the electromagnetic valve current in a state where the switching element 14 is switched from the off state to the on state in a normal state of the electromagnetic valve 2.

As illustrated in the timing chart TC1 in FIG. 2, the vehicle power supply 4 constantly outputs a power supply voltage having a voltage value VB. When the switching element 14 is switched from the off state to the on state at time t0, a voltage across both ends of the solenoid coil 3 of the electromagnetic valve 2 (hereinafter, the electromagnetic valve voltage) rapidly increases from 0 [V] to Vc [V]. As a result, the electromagnetic valve current gradually increases. Then, as the electromagnetic valve current increases, the magnetic attraction force increases, the movable core moves during a period from time t1 to time t2, and the electromagnetic valve 2 enters the open valve state. When the movable core moves, as indicated by a dashed circle CL1, a current singularity that changes from decrease to increase occurs in the temporal change of the electromagnetic valve current.

A timing chart TC2 in FIG. 2 illustrates temporal changes of the power supply voltage, the electromagnetic valve voltage, and the electromagnetic valve current in a case where the switching element 14 is switched from the off state to the on state when the electromagnetic valve 2 is stuck.

As illustrated in the timing chart TC2 in FIG. 2, the vehicle power supply 4 constantly outputs the power supply voltage having the voltage value VB. When the switching element 14 is switched from the off state to the on state at the time t0, the electromagnetic valve voltage rapidly increases from 0 [V] to Vc [V]. As a result, the electromagnetic valve current gradually increases. However, since the movable core does not move due to sticking although the movable core moves during a period from the time t1 to the time t2 in the normal state, the current singularity does not occur at the time t2.

Similarly to the timing chart TC2, a timing chart TC3 in FIG. 2 illustrates temporal changes of the power supply voltage, the electromagnetic valve voltage, and the electromagnetic valve current in a case where the switching element 14 is switched from the off state to the on state when the electromagnetic valve 2 is stuck. However, the timing chart TC3 is different from the timing chart TC2 in that a rapid fluctuation of the power supply voltage occurs while the electromagnetic valve current is increasing.

As illustrated in the timing chart TC3 in FIG. 2, the power supply voltage rapidly decreases from VB [V] to V1 [V] at the time t1. As a result, the electromagnetic valve voltage rapidly decreases from Vc [V] to V2 [V]. Furthermore, at the time t2, the power supply voltage rapidly increases from V1 [V] to VB [V]. As a result, the electromagnetic valve voltage rapidly increases from V2 [V] to Vc [V]. Therefore, although the movable core does not move due to sticking, a current singularity occurs at the time t2 as indicated by a dashed circle CL2. That is, there is a possibility that it is determined that the electromagnetic valve 2 is normal despite the occurrence of sticking in the electromagnetic valve 2.

Next, a procedure of failure determination processing executed by the CPU 21 of the microcomputer 19 will be described. The failure determination processing is processing executed at each arrival of a timing at which the electromagnetic valve 2 is switched from the valve non-energized state to the valve energized state.

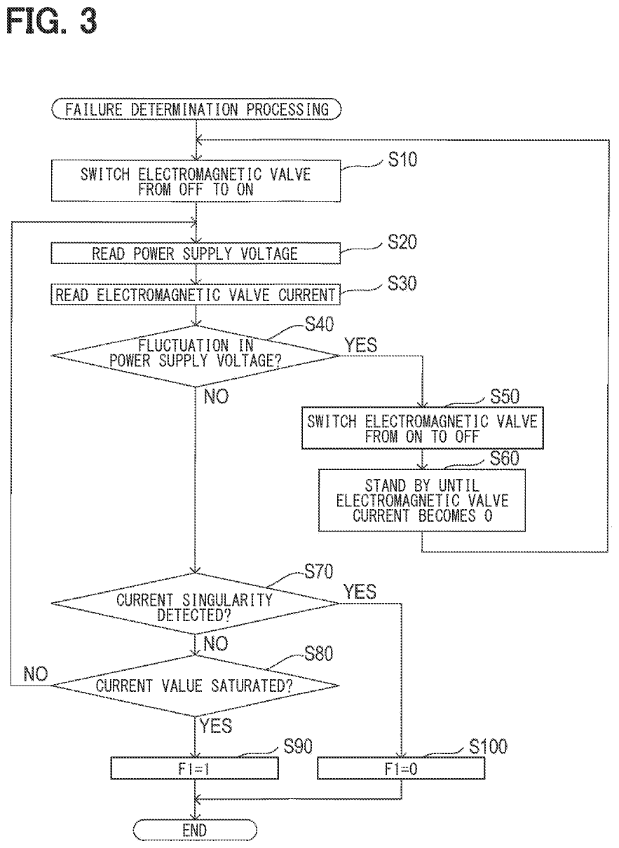

When the failure determination processing is executed, as illustrated in FIG. 3, the CPU 21 first switches the electromagnetic valve 2 from the off state to the on state in S10. Specifically, the CPU 21 switches the switching element 14 from the off state to the on state.

Then, in S20, the CPU 21 reads the power supply voltage. Specifically, the CPU 21 acquires a voltage detection signal from the voltage detection circuit 17, calculates a power supply voltage value on the basis of the acquired voltage detection signal, and stores the calculated power supply voltage value in the RAM 23.

Then, in S30, the CPU 21 reads an electromagnetic valve voltage. Specifically, the CPU 21 acquires a current detection signal from the current detection circuit 16, calculates an electromagnetic valve current value on the basis of the acquired current detection signal, and stores the calculated electromagnetic valve current value in the RAM 23.

Then, in S40, the CPU 21 determines whether there is a fluctuation in the power supply voltage. Specifically, the CPU 21 determines whether a difference between the power supply voltage value calculated in previous S20 and the power supply voltage value calculated in the current S20 is greater than or equal to a voltage fluctuation determination value set in advance.

When there is a fluctuation in the power supply voltage, the CPU 21 switches the electromagnetic valve 2 from the on state to the off state in S50. Specifically, the CPU 21 switches the switching element 14 from the on state to the off state.

In S60, the CPU 21 reads the electromagnetic valve signal and stands by until the electromagnetic valve current value becomes 0. When the electromagnetic valve current value becomes 0, the CPU 21 proceeds to S10.

When there is no fluctuation in the power supply voltage in S40, the CPU 21 determines in S50 whether a current singularity has been detected. Specifically, the CPU 21 determines that a current singularity has been detected when the electromagnetic valve current value continuously decreases during a period from before a preset first singularity determination time to the previous failure determination processing, and the electromagnetic valve current value changes from decrease to increase in the current failure determination processing.

When a current singularity has not been detected, the CPU 21 determines in S80 whether the electromagnetic valve current value is saturated. Specifically, the CPU 21 calculates a difference between the electromagnetic valve current value calculated in previous S30 and the electromagnetic valve current value calculated in current S30 (hereinafter, an electromagnetic valve current difference), and sequentially stores the calculated electromagnetic valve current values in the RAM 23. Then, on the basis of the plurality of stored electromagnetic valve current values, the CPU 21 determines that the electromagnetic valve current value is saturated when the electromagnetic valve current value continues to be less than a preset saturation determination value for a preset saturation determination time.

Here, when the electromagnetic valve current value is not saturated, the CPU 21 proceeds to S20.

On the other hand, when the electromagnetic valve current value is saturated, the CPU 21 sets an electromagnetic valve failure flag F1 provided in the RAM 23 in S90, and ends the failure determination processing. In the following description, setting a flag indicates setting a value of the flag to 1, and clearing a flag indicates setting a value of the flag to 0.

When the current singularity is detected in S70, the CPU 21 clears the electromagnetic valve failure flag F1 in S100, and ends the failure determination processing.

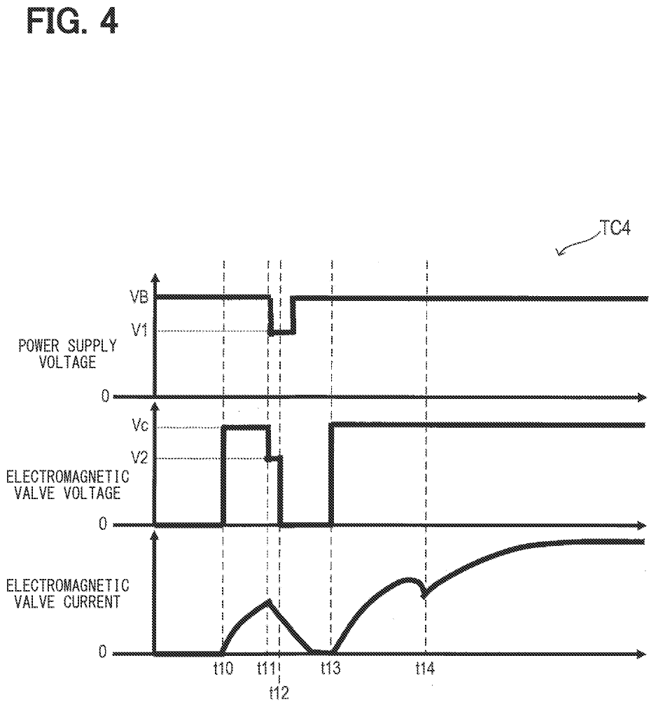

A timing chart TC4 in FIG. 4 illustrates temporal changes of the power supply voltage, the electromagnetic valve voltage, and the electromagnetic valve current in a state where a rapid fluctuation in the power supply voltage occurs in the normal state of the electromagnetic valve 2 according to the first embodiment.

As illustrated in the timing chart TC4 in FIG. 4, the vehicle power supply 4 constantly outputs the power supply voltage having the voltage value VB. When the switching element 14 is switched from the off state to the on state at time t10, the electromagnetic valve voltage rapidly increases from 0 [V] to Vc [V]. As a result, the electromagnetic valve current gradually increases.

Then, at time t11, the power supply voltage rapidly decreases from VB [V] to V1 [V]. As a result, the electromagnetic valve voltage rapidly decreases from Vc [V] to V2 [V], and the electromagnetic valve current also decreases.

When the switching element 14 is switched from the on state to the off state at time t12 by the power supply voltage rapidly decreasing at the time t11, the electromagnetic valve voltage rapidly decreases from V2 [V] to 0 [V], and the electromagnetic valve current gradually decreases.

When the electromagnetic valve current becomes 0, the switching element 14 is switched from the off state to the on state at time t13, and the electromagnetic valve voltage rapidly increases from 0 [V] to Vc [V]. As a result, the electromagnetic valve current gradually increases. Then, as the electromagnetic valve current increases, the magnetic attraction force increases, the movable core moves, and a current singularity occurs at time t14.

The ECU 1 configured as described above controls the electromagnetic valve 2 mounted on the vehicle, and includes the shunt resistor 15, the current detection circuit 16, the voltage detection circuit 17, and the microcomputer 19.

The shunt resistor 15 and the current detection circuit 16 detect the electromagnetic valve current flowing through the electromagnetic valve 2 after power supply to the electromagnetic valve 2 is started. The voltage detection circuit 17 detects a power supply voltage of the vehicle power supply 4.

The microcomputer 19 detects a current singularity in a temporal change of the electromagnetic valve current (hereinafter, the electromagnetic valve current singularity).

The microcomputer 19 detects a stuck failure of the electromagnetic valve 2 on the basis of a detection result of the electromagnetic valve current singularity.

The microcomputer 19 determines whether a fluctuation in the power supply voltage has occurred on the basis of the detection result of the voltage detection circuit 17, and inhibits a detection of a stuck failure until a preset inhibition release condition is satisfied when determining that a fluctuation in the power supply voltage has occurred. The inhibition release condition in the present embodiment is that the electromagnetic valve current becomes 0.

The ECU 1 as described above enables to suppress the occurrence of a situation in which the failed electromagnetic valve 2 is erroneously determined to be normal due to a voltage fluctuation in the vehicle power supply 4, and enables to improve detection accuracy of an electromagnetic valve failure.

In the embodiment described above, the ECU 1 corresponds to an electronic control unit, the shunt resistor 15 and the current detection circuit 16 correspond to an electromagnetic valve current detector, the vehicle power supply 4 corresponds to a direct-current power supply, and the voltage detection circuit 17 corresponds to a power supply voltage detector.

Further, S70 corresponds to processing as an electromagnetic valve current singularity detector, S90 and S100 correspond to processing as an electromagnetic valve current failure detector, and S40 to S60 correspond to processing as a failure detection inhibitor.

### Second Embodiment

Hereinafter, a second embodiment of the present disclosure will be described with reference to the drawings. In the second embodiment, differences from the first embodiment will be described. Common configurations are denoted by the same reference numerals.

The ECU 1 according to the second embodiment is different from the ECU 1 according to the first embodiment in that the failure determination processing is changed.

Next, a procedure of the failure determination processing according to the second embodiment will be described.

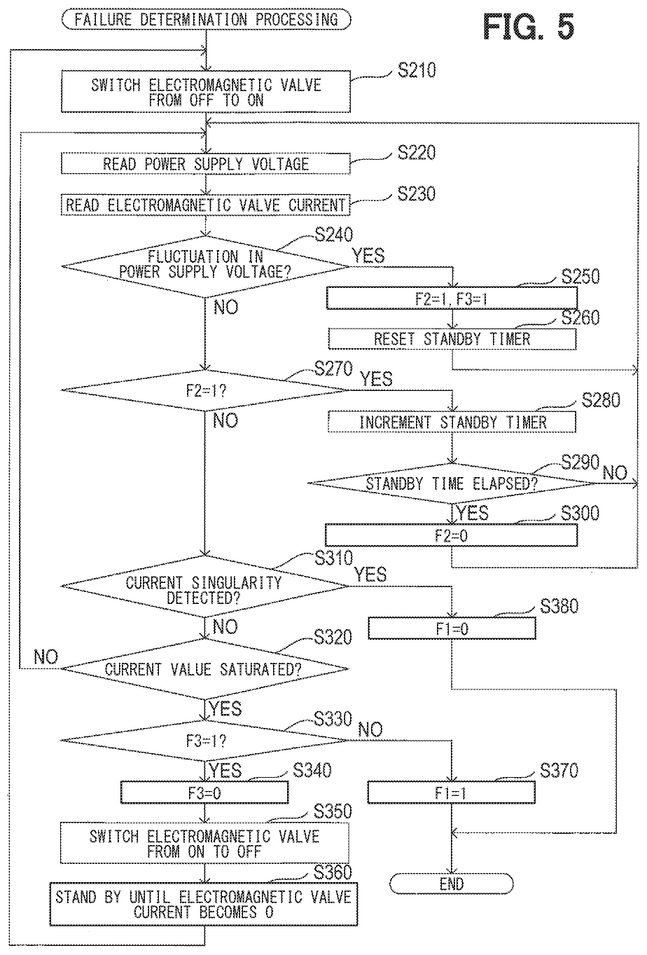

When the failure determination processing according to the second embodiment is executed, the CPU 21 first switches the electromagnetic valve 2 from the off state to the on state in S210 as illustrated in FIG. 5.

Then, in S220, the CPU 21 reads the power supply voltage. Then, in S230, the CPU 21 reads the electromagnetic valve current.

Then, in S240, the CPU 21 determines whether here is a fluctuation in the power supply voltage.

Here, when there is a fluctuation in the power supply voltage, the CPU 21 sets a voltage stabilization standby flag F2 and an invalid flag F3 provided in the RAM 23 in S250. The CPU 21 resets (that is, sets to 0) a standby timer provided in the RAM 23 in S260, and proceeds to S220.

When there is no fluctuation in the power supply voltage in S240, the CPU 21 determines in S270 whether the voltage stabilization standby flag F2 has been set, Here, when the voltage stabilization standby flag F2 has been set, the CPU 21 increments (that is, adds 1 to) the standby timer in S280.

Then, in S290, the CPU 21 determines whether a preset standby time has elapsed. Specifically, the CPU 21 determines whether a value of the standby timer is greater than or equal to an equivalent standby time value that is equivalent to the standby time.

Here, when the standby time has not elapsed, the CPU 21 proceeds to S220. On the other hand, when the standby time has elapsed, the CPU 21 clears the voltage stabilization standby flag F2 in S300, and proceeds to S220.

When the voltage stabilization standby flag F2 has been cleared in S270, the CPU 21 determines in S310 whether a current singularity has been detected. When a current singularity has not been detected, the CPU 21 determines in S320 whether the electromagnetic valve current value is saturated.

Here, when the electromagnetic valve current value is not saturated, the CPU 21 proceeds to S220. When the electromagnetic valve current value is saturated, the CPU 21 determines in S330 whether the invalid flag F3 has been set.

Here, when the invalid flag F3 has been set, the CPU 21 dears the invalid flag F3 in S340. Then, the CPU 21 switches the electromagnetic valve 2 from the on state to the off state in S350. In S360, the CPU 21 stands by until the electromagnetic valve current value becomes 0, and proceeds to S210 when the electromagnetic valve current value becomes 0.

When the invalid flag F3 has been cleared in S330, the CPU 21 clears the electromagnetic valve failure flag F1 in S370, and ends the failure determination processing.

When the current singularity is detected in S310, the CPU 21 clears the electromagnetic valve failure flag F1 in S380, and ends the failure determination processing.

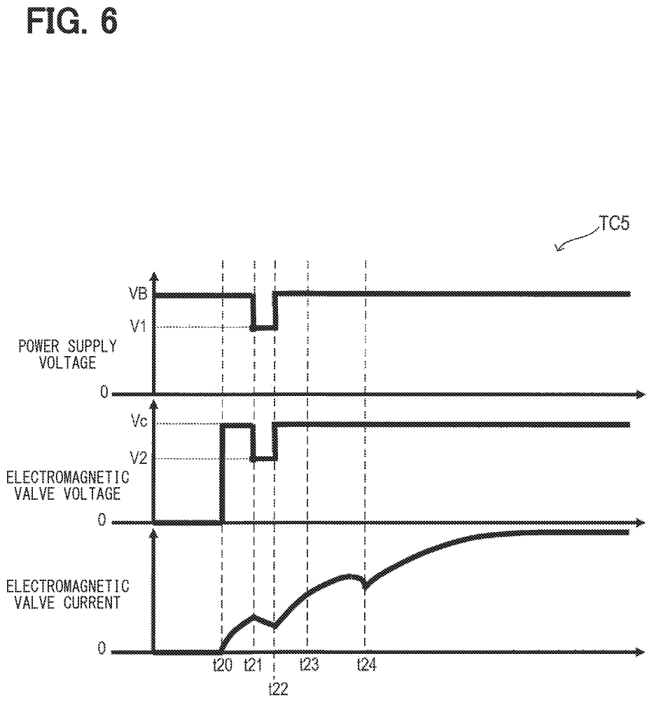

A timing chart TC5 in FIG. 6 illustrates temporal changes of the power supply voltage, the electromagnetic valve voltage, and the electromagnetic valve current in a state where a rapid fluctuation in the power supply voltage occurs in the normal state of the electromagnetic valve 2 according to the second embodiment.

As illustrated in the timing chart TC5 in FIG. 6, the vehicle power supply 4 constantly outputs the power supply voltage having the voltage value VB. When the switching element 14 is switched from the off state to the on state at time t20, the electromagnetic valve voltage rapidly increases from 0 [V] to Vc [V]. As a result, the electromagnetic valve current gradually increases.

Then, at time t21, the power supply voltage rapidly decreases from VB [V] to V1 [V]. As a result, the voltage stabilization standby flag F2 and the invalid flag F3 are set. The electromagnetic valve voltage rapidly decreases from Vc [V] to V2 [V], and the electromagnetic valve current also decreases.

Furthermore, at the time t22, the power supply voltage rapidly increases from V1 [V] to VB [V]. Thus, the electromagnetic valve voltage rapidly increases from V2 [V] to Vc [V], and a current singularity occurs.

However, the invalid flag F3 is set at the time t22.

Thereafter, the voltage stabilization standby flag F2 is cleared at time t23 while the electromagnetic valve current gradually increases. Then, as the electromagnetic valve current increases, the magnetic attraction force increases, the movable core moves, and a current singularity occurs at time t24. As a result, the electromagnetic valve failure flag F1 is cleared.

The ECU 1 configured as described above controls the electromagnetic valve 2 mounted on the vehicle, and includes the shunt resistor 15, the current detection circuit 16, the voltage detection circuit 17, and the microcomputer 19.

The microcomputer 19 detects an electromagnetic valve current singularity in a temporal change of the electromagnetic valve current.

The microcomputer 19 detects a stuck failure of the electromagnetic valve 2 on the basis of a detection result of the electromagnetic valve current singularity.

The microcomputer 19 determines whether a fluctuation in the power supply voltage VB has occurred on the basis of the detection result of the voltage detection circuit 17, and inhibits a detection of a stuck failure until a preset inhibition release condition is satisfied when determining that a fluctuation in the power supply voltage VB has occurred. The inhibition release condition according to the present embodiment is that a preset standby time elapses after the fluctuation in the power supply voltage VB occurs.

The ECU 1 as described above enables to suppress the occurrence of a situation in which the failed electromagnetic valve 2 is erroneously determined to be normal due to a voltage fluctuation in the vehicle power supply 4, and enables to improve detection accuracy of an electromagnetic valve failure.

In the embodiment described above, S310 corresponds to processing as the electromagnetic valve current singularity detector, S370 and S380 correspond to processing as the electromagnetic valve current failure detector, S240 to S300 correspond to processing as the failure detection inhibitor, and the standby time corresponds to an inhibition time.

### Third Embodiment

Hereinafter, a third embodiment of the present disclosure will be described with reference to the drawings. In the third embodiment, differences from the first embodiment will be described. Common configurations are denoted by the same reference numerals.

The ECU 1 according to the third embodiment is different from the ECU 1 according to the first embodiment in that the failure determination processing is changed.

Next, a procedure of the failure determination processing according to the third embodiment will be described.

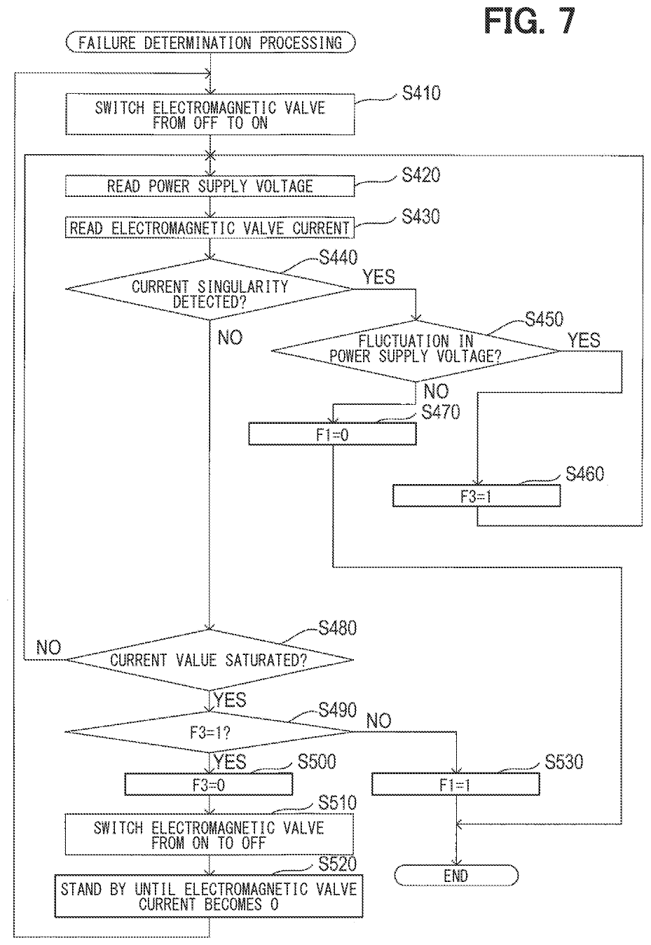

When the failure determination processing according to the third embodiment is executed, the CPU 21 first switches the electromagnetic valve 2 from the off state to the on state in S410 as illustrated in FIG. 7.

Then, in S420, the CPU 21 reads the power supply voltage. In S430, the CPU 21 reads the electromagnetic valve current.

In S440, the CPU 21 determines whether a current singularity has been detected. Here, when a current singularity has been detected, the CPU 21 determines in S450 whether there is a fluctuation in the power supply voltage. Here, when there is a fluctuation in the power supply voltage, the CPU 21 sets the invalid flag F3 in S460 and proceeds to S420. On the other hand, when there is no fluctuation in the power supply voltage, the CPU 21 clears the electromagnetic valve failure flag F1 in S470, and ends the failure determination processing.

When a current singularity has not been detected in S440, the CPU 21 determines in S480 whether the electromagnetic valve current value is saturated. Here, when the electromagnetic valve current value is not saturated, the CPU 21 proceeds to S420. When the electromagnetic valve current value is saturated, the CPU 21 determines in S490 whether the invalid flag F3 has been set.

Here, when the invalid flag F3 has been set, the CPU 21 clears the invalid flag F3 in S500. Then, the CPU 21 switches the electromagnetic valve 2 from the on state to the off state in S510. In S520, the CPU 21 stands by until the electromagnetic valve current value becomes 0, and proceeds to S410 when the electromagnetic valve current value becomes 0.

When the invalid flag F3 has been cleared in S490, the CPU 21 sets the electromagnetic valve failure flag F1 in S530, and ends the failure determination processing.

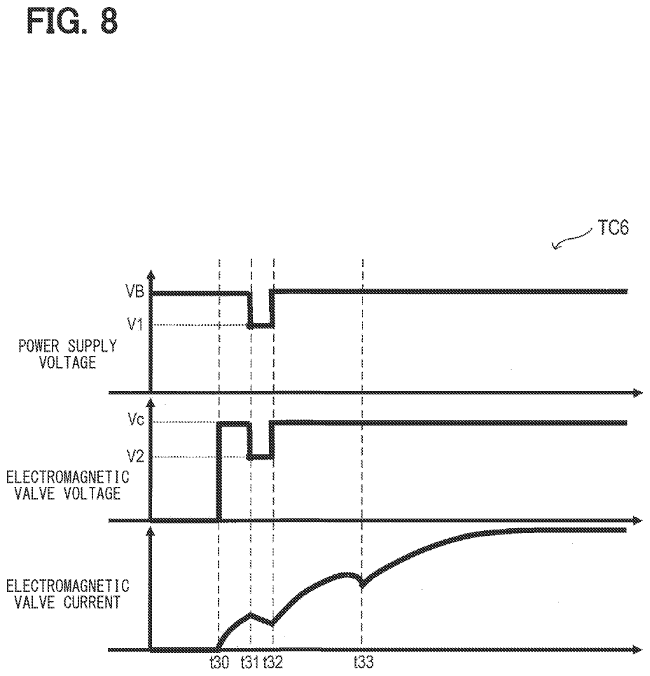

A timing chart TC6 in FIG. 8 illustrates temporal changes of the power supply voltage, the electromagnetic valve voltage, and the electromagnetic valve current in a state where a rapid fluctuation in the power supply voltage occurs in the normal state of the electromagnetic valve 2 according to the third embodiment.

As illustrated in the timing chart TC6 in FIG. 8, the vehicle power supply 4 constantly outputs the power supply voltage having the voltage value VB. When the switching element 14 is switched from the off state to the on state at time t30, the electromagnetic valve voltage rapidly increases from 0 [V] to Vc [V]. As a result, the electromagnetic valve current gradually increases.

Then, at time t31, the power supply voltage rapidly decreases from VB [V] to V1 [V]. As a result, the invalid flag F3 is set. The electromagnetic valve voltage rapidly decreases from Vc [V] to V2 [V], and the electromagnetic valve current also decreases.

Furthermore, at the time t32, the power supply voltage rapidly increases from V1 [V] to VB [V]. Thus, the electromagnetic valve voltage rapidly increases from V2 [V] to Vc [V], and a current singularity occurs.

However, the invalid flag F3 has been set at the time t32.

Then, as the electromagnetic valve current increases, the magnetic attraction force increases, the movable core moves, and a current singularity occurs at time t33. Since there has not been a fluctuation in the power supply voltage by this point of time, the electromagnetic valve failure flag F1 is cleared.

The ECU 1 configured as described above controls the electromagnetic valve 2 mounted on the vehicle, and includes the shunt resistor 15, the current detection circuit 16, the voltage detection circuit 17, and the microcomputer 19.

The microcomputer 19 detects an electromagnetic valve current singularity in a temporal change of the electromagnetic valve current.

The microcomputer 19 detects a stuck failure of the electromagnetic valve 2 on the basis of a detection result of the electromagnetic valve current singularity.

The microcomputer 19 determines whether a fluctuation in the power supply voltage has occurred on the basis of the detection result of the voltage detection circuit 17. When determining that a fluctuation in the power supply voltage has occurred, the microcomputer 19 invalidates at least the detection result of the electromagnetic valve current singularity corresponding to a time point at which the fluctuation in the power supply voltage has occurred.

The ECU 1 as described above enables to suppress the occurrence of a situation in which the failed electromagnetic valve 2 is erroneously determined to be normal due to a voltage fluctuation in the vehicle power supply 4, and enables to improve detection accuracy of an electromagnetic valve failure.

In the embodiment described above, S440 corresponds to processing as the electromagnetic valve current singularity detector, S470 and S530 correspond to processing as the electromagnetic valve current failure detector, S450 and S460 correspond to processing as an invalidator.

### Fourth Embodiment

Hereinafter, a fourth embodiment of the present disclosure will be described with reference to the drawings. In the fourth embodiment, differences from the first embodiment will be described. Common configurations are denoted by the same reference numerals.

The ECU 1 according to the fourth embodiment is different from the ECU 1 according to the first embodiment in that the configuration of the ECU 1 is changed and that regenerative current failure determination processing is executed instead of the failure determination processing.

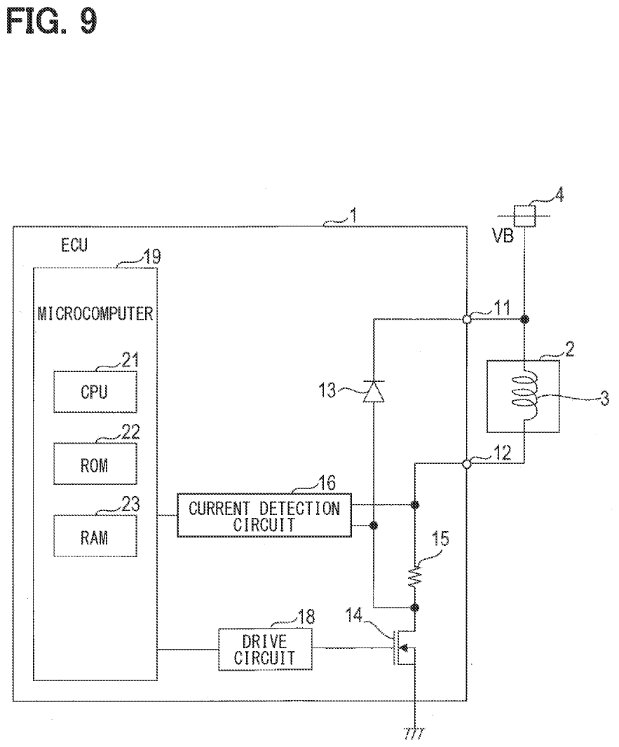

As illustrated in FIG. 9, the ECU 1 according to the fourth embodiment is different from the ECU 1 according to the first embodiment in that the voltage detection circuit 17 is omitted and that connections of the diode 13, the switching element 14, and the shunt resistor 15 are changed.

That is, the diode 13 has the anode connected to the second end of the shunt resistor 15 and the cathode connected to the positive terminal 11. The first end of the switching element 14 is connected to the second end of the shunt resistor 15, and the second end of the switching element 14 is grounded. The first end of the shunt resistor 15 is connected to the negative terminal 12.

When the switching element 14 is in the on state, a current flows from the vehicle power supply 4 to the solenoid coil 3. When the switching element 14 is in the off state, energy accumulated in the solenoid coil 3 when the switching element 14 is in the on state causes a current to continuously flow (that is, circulate) to the solenoid coil 3 via the diode 13.

The same current as the current flowing through the diode 13 flows through the shunt resistor 15. Therefore, the current detection circuit 16 detects the current (that is, regenerative current) flowing through the diode 13 immediately after the switching element 14 is switched from the on state to the off state.

Next, a procedure of the regenerative current failure determination processing according to the fourth embodiment will be described. The regenerative current failure determination processing is processing executed at each arrival of a timing at which the electromagnetic valve 2 is switched from the valve energized state to the valve non-energized state.

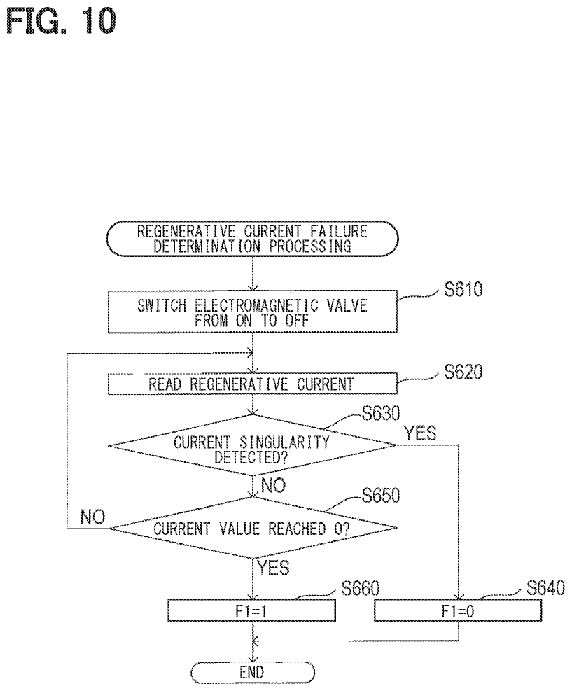

When the regenerative current failure determination processing is executed, as illustrated in FIG. 10, the CPU 21 first switches the electromagnetic valve 2 from the on state to the off state in S610. In S620, the CPU 21 reads the regenerative current. Specifically, the CPU 21 acquires a current detection signal from the current detection circuit 16, calculates a regenerative current value on the basis of the acquired current detection signal, and stores the calculated regenerative current value in the RAM 23.

In S630, the CPU 21 determines whether a current singularity has been detected. Specifically, the CPU 21 determines that a current singularity has been detected when the regenerative current value continuously increases during a period from before a preset second singularity determination time to the previous regenerative current failure determination processing, and the regenerative current value changes from increase to decrease in the current regenerative current failure determination processing.

Here, when the current singularity has been detected, the CPU 21 clears the electromagnetic valve failure flag F1 in S640, and ends the regenerative current failure determination processing. On the other hand, when a current singularity has not been detected, the CPU 21 determines in S650 whether the regenerative current value has reached 0. Here, when the regenerative current value has not reached 0, the CPU 21 proceeds to S620. On the other hand, when the regenerative current value has reached 0, the CPU 21 sets the electromagnetic valve failure flag F1 in S640, and ends the regenerative current failure determination processing.

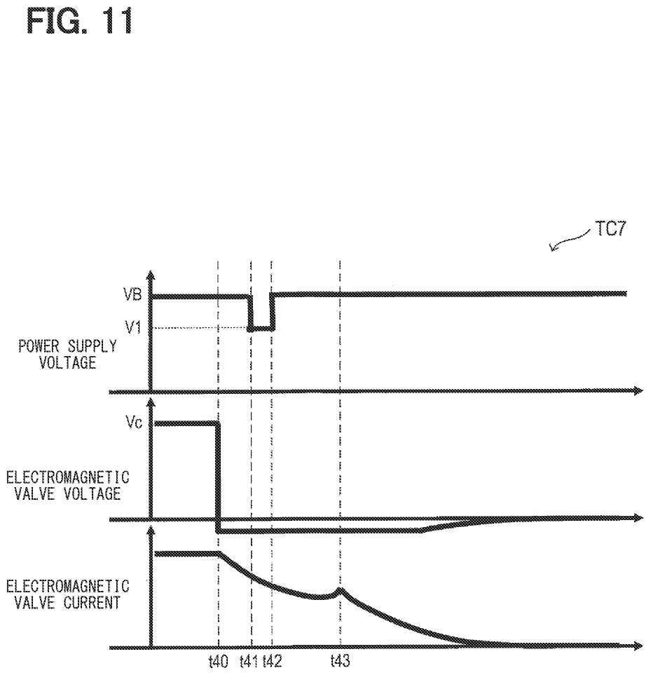

A timing chart TC7 in FIG. 11 illustrates temporal changes of the power supply voltage, the electromagnetic valve voltage, and the electromagnetic valve current in a state where a rapid fluctuation in the power supply voltage occurs in the normal state of the electromagnetic valve 2 according to the fourth embodiment.

As illustrated in the timing chart TC7 in FIG. 11, the vehicle power supply 4 constantly outputs the power supply voltage having the voltage value VB. When the switching element 14 is switched from the on state to the off state at time t40, the electromagnetic valve voltage rapidly decreases from Vc [V] to 0 [V]. As a result, the electromagnetic valve current gradually decreases.

Then, at time t41, the power supply voltage rapidly decreases from VB [V] to V1 [V]. The electromagnetic valve current is not affected by this rapid decrease in the power supply voltage.

Furthermore, at the time t42, the power supply voltage rapidly increases from V1 [V] to VB [V]. The electromagnetic valve current is not affected by this rapid increase in the power supply voltage.

Then, as the electromagnetic valve current decreases, the magnetic attraction force decreases. Then, the movable core moves, and the electromagnetic valve 2 enters the closed valve state. The movement of the movable core generates a current singularity that changes from increase to decrease at time t43.

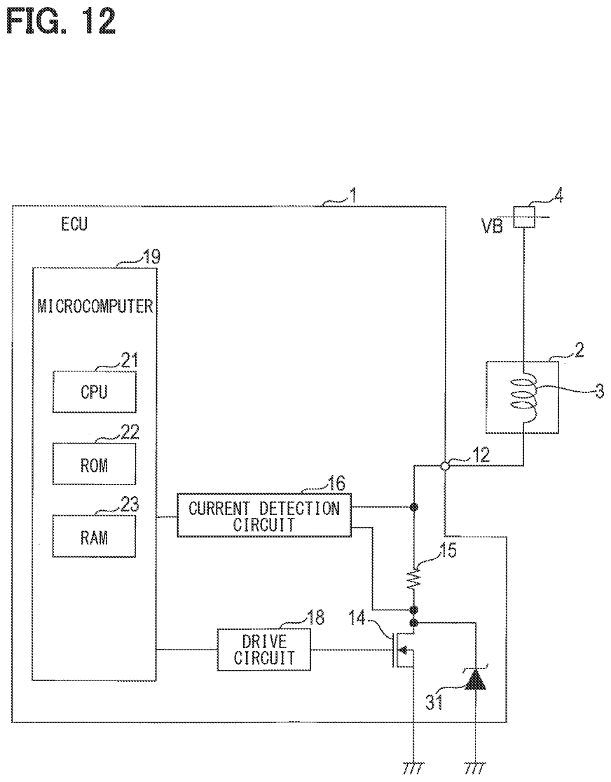

FIG. 12 is a diagram illustrating a configuration of the ECU 1 to which a Zener diode 31 is connected in order to damp a surge generated when the electromagnetic valve 2 is turned into the off state.

In the ECU 1 illustrated in FIG. 12, an anode of the Zener diode 31 is grounded, and a cathode of the Zener diode 31 is connected to a connection point between the switching element 14 and the shunt resistor 15. The diode 13 is omitted.

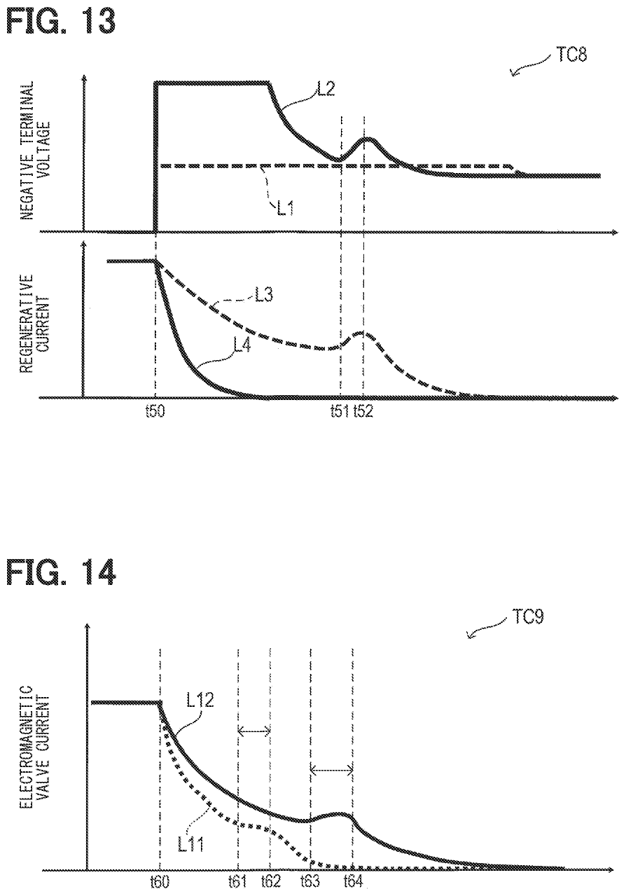

A timing chart TC8 in FIG. 13 illustrates temporal changes of a voltage of the negative terminal 12 (hereinafter, negative terminal voltage) and the electromagnetic valve current in a case where the electromagnetic valve 2 is switched from the on state to the off state. A line L1 of the timing chart TC8 indicates a temporal change of the negative terminal voltage in the ECU 1 according to the fourth embodiment. A line L2 indicates a temporal change of the negative terminal voltage in the ECU 1 illustrated in FIG. 12. A line L3 indicates a temporal change of the electromagnetic valve current in the ECU 1 according to the fourth embodiment. A line L4 indicates a temporal change of the electromagnetic valve current in the ECU 1 illustrated in FIG. 12.

As illustrated in FIG. 12, when the switching element 14 is switched from the on state to the off state at time t50, the negative terminal voltage rapidly increases, and the electromagnetic valve current gradually decreases. The negative terminal voltage of the ECU 1 illustrated in FIG. 12 is larger than the negative terminal voltage of the ECU 1 according to the fourth embodiment. The electromagnetic valve current of the ECU 1 illustrated in FIG. 12 decreases faster than the electromagnetic valve current of the ECU 1 according to the fourth embodiment.

Then, when the movable core moves between time t51 and time t52, a current singularity occurs in the ECU 1 according to the fourth embodiment. However, in the ECU 1 illustrated in FIG. 12, the electromagnetic valve current is consumed before the movable core moves, and a current singularity does not occur. Therefore, in order to generate a current singularity, it is desirable not to use the Zener diode 31.

A timing chart TC9 in FIG. 14 illustrates a temporal change of the electromagnetic valve current in a state where the electromagnetic valve 2 is switched from the on state to the off state. A line L11 of the timing chart TC9 indicates a temporal change in the electromagnetic valve current when the diode 13 is a rectifier diode. A line L12 of the timing chart TC9 indicates a temporal change in the electromagnetic valve current when the diode 13 is a Schottky barrier diode. A forward voltage Vf of the rectifier diode is larger than a forward voltage of the Schottky barrier diode. In the present embodiment, the forward voltage Vf of the rectifier diode is 0.7 V, and the forward voltage Vf of the Schottky barrier diode is 0.4 V.

As illustrated in FIG. 14, when the switching element 14 is switched from the on state to the off state at time t60, the electromagnetic valve current gradually decreases. However, when the diode 13 is a rectifier diode, the electromagnetic valve current decreases faster than when the diode 13 is a Schottky barrier diode.

When the diode 13 is a rectifier diode, the movable core moves during a period from time t61 to time t62. When the diode 13 is a Schottky barrier diode, the movable core moves during a period from time t63 to time t64. As illustrated in FIG. 14, by using a Schottky barrier diode for the diode 13, it is possible to increase lifting of the electromagnetic valve current during a valve operation, and remarkably generate a current singularity.

The ECU 1 configured as described above controls the electromagnetic valve 2 mounted on the vehicle, and includes the shunt resistor 15, the current detection circuit 16, and the microcomputer 19.

The shunt resistor 15 and the current detection circuit 16 detect the regenerative current circulating through the electromagnetic valve 2 immediately after the power supply to the electromagnetic valve 2 is stopped.

The microcomputer 19 detects a current singularity in a temporal change of the regenerative current (hereinafter, the regenerative current singularity). Then, the microcomputer 19 detects a stuck failure of the electromagnetic valve 2 on the basis of a detection result of the regenerative current singularity.

The ECU 1 as described above detects a regenerative current singularity of a regenerative current that is not affected by a voltage fluctuation in the vehicle power supply 4. Thus, the ECU 1 enables to suppress the occurrence of a situation in which the failed electromagnetic valve 2 is erroneously determined to be normal due to a voltage fluctuation in the vehicle power supply 4, and enables to improve the detection accuracy of an electromagnetic valve failure.

The ECU 1 includes the diode 13 through which a regenerative current flows. As a result, the ECU 1 enables to gradually reduce the regenerative current, and enables to easily generate a regenerative current singularity in the temporal change of the regenerative current.

In the embodiment described above, the shunt resistor 15 and the current detection circuit 16 correspond to a regenerative current detector, S630 corresponds to processing as a regenerative current singularity detector, S640 and S660 correspond to processing as a regenerative current failure detector, and the diode 13 corresponds to a freewheeling diode.

### Fifth Embodiment

Hereinafter, a fifth embodiment of the present disclosure will be described with reference to the drawings. In the fifth embodiment, differences from the fourth embodiment will be described. Common configurations are denoted by the same reference numerals.

The ECU 1 according to the fifth embodiment is different from the ECU 1 according to the fourth embodiment in that the configuration of the ECU 1 is changed and that the failure determination processing is executed instead of the regenerative current failure determination processing.

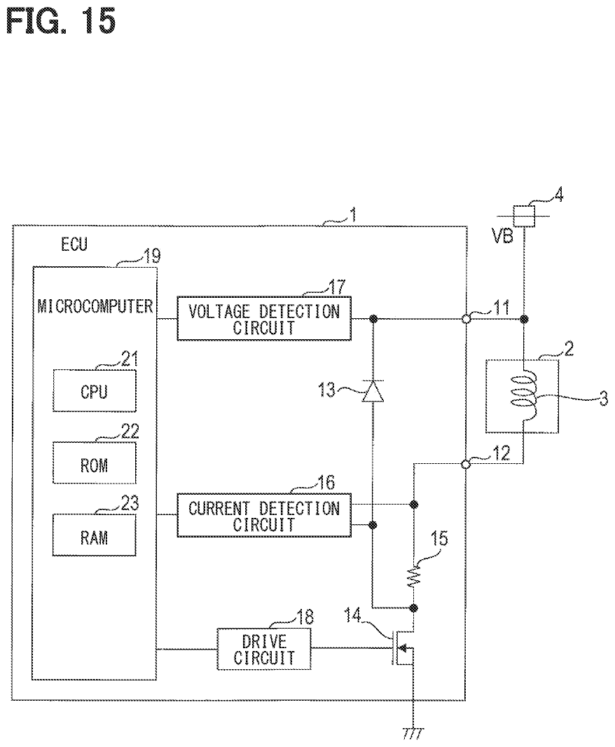

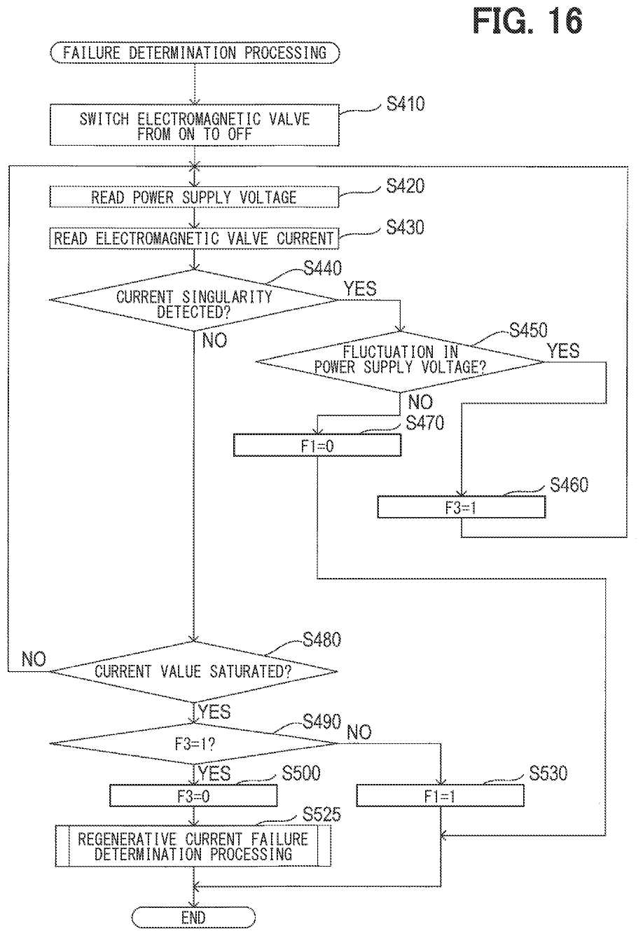

The ECU 1 according to the fifth embodiment is different from the ECU 1 according to the fourth embodiment in that the voltage detection circuit 17 is added as illustrated in FIG. 15. The voltage detection circuit 17 detects a voltage at the positive terminal 11 and outputs a voltage detection signal indicating the detection result to the microcomputer 19.

Next, a procedure of the failure determination processing according to the fifth embodiment will be described. The failure determination processing is processing executed at each arrival of a timing at which the electromagnetic valve 2 is switched from the valve non-energized state to the valve energized state.

As illustrated in FIG. 16, the failure determination processing according to the fifth embodiment is different from the failure determination processing according to the third embodiment in that the processings of S510 and S520 are omitted and the processing of S525 is added.

That is, when the processing of S500 ends, the CPU 21 executes the regenerative current failure determination processing according to the fourth embodiment in S525, and ends the failure determination processing.

The ECU 1 configured as described above controls the electromagnetic valve 2 mounted on the vehicle, and includes the shunt resistor 15, the current detection circuit 16, the voltage detection circuit 17, and the microcomputer 19.

The shunt resistor 15 and the current detection circuit 16 detect the electromagnetic valve current flowing through the electromagnetic valve 2 after power supply to the electromagnetic valve 2 is started. The voltage detection circuit 17 detects a power supply voltage of the vehicle power supply 4.

The microcomputer 19 detects an electromagnetic valve current singularity in a temporal change of the electromagnetic valve current.

The microcomputer 19 detects a stuck failure of the electromagnetic valve 2 on the basis of a detection result of the electromagnetic valve current singularity.

The microcomputer 19 determines whether a fluctuation in the power supply voltage has occurred on the basis of the detection result of the voltage detection circuit 17. When determining that a fluctuation in the power supply voltage has occurred, the microcomputer 19 invalidates at least the detection result of the electromagnetic valve current singularity corresponding to a time point at which the fluctuation in the power supply voltage has occurred.

The shunt resistor 15 and the current detection circuit 16 detect the regenerative current circulating through the electromagnetic valve 2 immediately after the power supply to the electromagnetic valve 2 is stopped.

The microcomputer 19 detects a regenerative current singularity in the temporal change of the regenerative current. Then, the microcomputer 19 detects a stuck failure of the electromagnetic valve 2 on the basis of a detection result of the regenerative current singularity.

The ECU 1 as described above invalidates the detection result of the electromagnetic valve current singularity when a fluctuation in the power supply voltage occurs, and detects a regenerative current singularity of a regenerative current that is not affected by the voltage fluctuation in the vehicle power supply 4. Thus, the ECU 1 enables to suppress the occurrence of a situation in which the failed electromagnetic valve 2 is erroneously determined to be normal due to a voltage fluctuation in the vehicle power supply 4, and enables to improve the detection accuracy of an electromagnetic valve failure.

In the embodiment described above, S440 corresponds to processing as the electromagnetic valve current singularity detector, S470 and S530 correspond to processing as the electromagnetic valve current failure detector, S450 and S560 correspond to processing as an invalidator.

Further, S525 corresponds to processing as the regenerative current singularity detector and the regenerative current failure detector.

### Sixth Embodiment

Hereinafter, a sixth embodiment of the present disclosure will be described with reference to the drawings. In the sixth embodiment, differences from the fourth embodiment will be described. Common configurations are denoted by the same reference numerals.

The ECU 1 according to the sixth embodiment is different from the ECU 1 according to the fourth embodiment in that the configuration of the ECU 1 is changed.

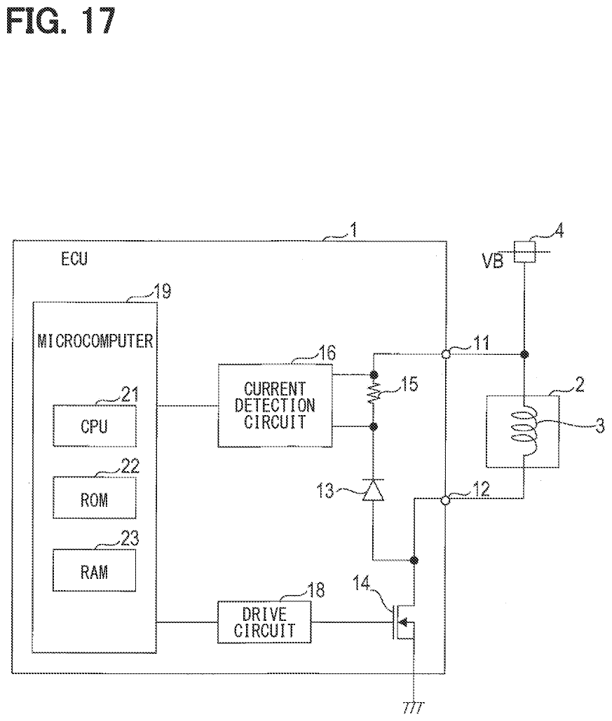

As illustrated in FIG. 17, the ECU 1 according to the sixth embodiment is different from the ECU 1 according to the fourth embodiment in that the connections of the diode 13, the switching element 14, and the shunt resistor 15 are changed.

That is, the diode 13 has the anode connected to the negative terminal 12 and the cathode connected to the second end of the shunt resistor 15. The first end of the switching element 14 is connected to the negative terminal 12, and the second end of the switching element 14 is grounded. The first end of the shunt resistor 15 is connected to the positive terminal 11.

In the ECU 1 configured as described above, the shunt resistor 15 and the current detection circuit 16 detect the regenerative current flowing in the energization path between the diode 13 and the vehicle power supply 4 that applies the power supply voltage to the electromagnetic valve 2.

Similarly to the ECU 1 according to the fourth embodiment, the ECU 1 described above enables to suppress the occurrence of a situation in which the failed electromagnetic valve 2 is erroneously determined to be normal due to a voltage fluctuation in the vehicle power supply 4, and enables to improve detection accuracy of an electromagnetic valve failure.

### Seventh Embodiment

Hereinafter, a seventh embodiment of the present disclosure will be described with reference to the drawings. In the seventh embodiment, differences from the sixth embodiment will be described. Common configurations are denoted by the same reference numerals.

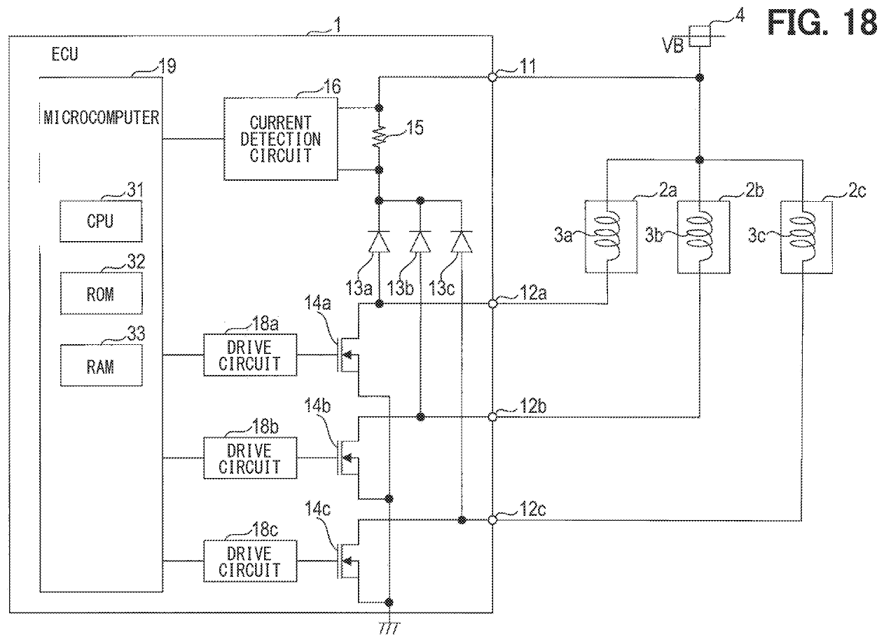

As illustrated in FIG. 18, the ECU 1 according to the seventh embodiment controls electromagnetic valves 2a, 2b, and 2c. The electromagnetic valves 2a,2b, and 2c are the same as the electromagnetic valve 2, and include solenoid coils 3a, 3b, and 3c, respectively, and a movable core (not illustrated). First ends of the solenoid coils 3a, 3b, and 3c are connected to a positive electrode of the vehicle power supply 4, and second ends of the solenoid coils 3a, 3b, and 3c are grounded.

The ECU 1 includes the positive terminal 11, negative terminals 12a, 12b, and 12c, diodes 13a, 13b, and 13c, switching elements 14a, 14b, and 14c, the shunt resistor 15, the current detection circuit 16, drive circuits 18a, 18b, and 18c, and the microcomputer 19.

The positive terminal 11 is connected to the first ends of the solenoid coils 3a, 3b, and 3c. The negative terminals 12a, 12b, and 12c are connected to the second ends of the solenoid coils 3a, 3b, and 3c, respectively.

Each of the diodes 13a, 13b, and 13c is the same as the diode 13, and has an anode connected to each of the negative terminals 12a, 12b, and 12c and a cathode connected to the second end of the shunt resistor 15.

Each of the switching elements 14a, 14b, and 14c is the same as the switching element 14, and is a transistor provided on an energization path from each of the solenoid coils 3a, 3b, and 3c to the ground.

First ends of the switching elements 14a, 14b, and 14c are connected to the negative terminals 12a, 12b, and 12c, respectively. Second ends of the switching elements 14a, 14b, and 14c are grounded. The first end of the shunt resistor 15 is connected to the positive terminal 11.

The drive circuits 18a, 18b, and 18c output, to the switching elements 14a,14b, and 14c, respectively, a drive signal for driving the switching elements 14a, 14b, and 14c such that the switching elements 14a, 14b, and 14c are in the on state or the off state on the basis of a control signal output from the microcomputer 19.

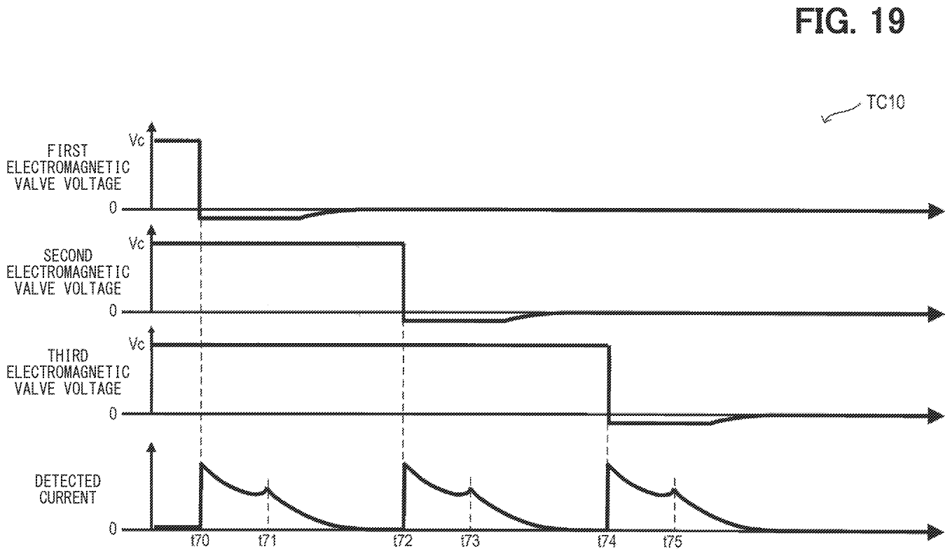

A timing chart TC10 in FIG. 19 illustrates temporal changes of voltages across both ends of the solenoid coils 3a, 3b, and 3c in a case where the electromagnetic valves 2a, 2b, and 2c are switched from the on state to the off state. Hereinafter, the voltages across both ends of the solenoid coils 3a, 3b, and 3c are referred to as first, second, and third electromagnetic valve voltages, respectively.

As illustrated in FIG. 19, when the switching element 14a is switched from the on state to the off state at time t70, the first electromagnetic valve voltage rapidly decreases from Vc [V] to 0 [V]. As a result, the current detected by the current detection circuit 16 (hereinafter, detected current) gradually decreases, and a current singularity occurs at time t71.

When the switching element 14b is switched from the on state to the off state at time t72, the second electromagnetic valve voltage rapidly decreases from Vc [V] to 0 [V]. As a result, the detected current gradually decreases, and a current singularity occurs at time t73.

When the switching element 14c is switched from the on state to the off state at time t74, the third electromagnetic valve voltage rapidly decreases from Vc [V] to 0 [V]. As a result, the detected current gradually decreases, and a current singularity occurs at time t75.

hi the ECU 1 configured as described above, the shunt resistor 15 and the current detection circuit 16 detect a regenerative current of each of a plurality of the electromagnetic valves 2a, 2b, and 2c. The ECU 1 as described above does not include three current detection circuits 16 corresponding to the electromagnetic valves 2a, 2b, and 2c, and thus enables to have a simplified configuration.

### Eighth Embodiment

Hereinafter, an eighth embodiment of the present disclosure will be described with reference to the drawings. In the eighth embodiment, differences from the fourth embodiment will be described. Common configurations are denoted by the same reference numerals.

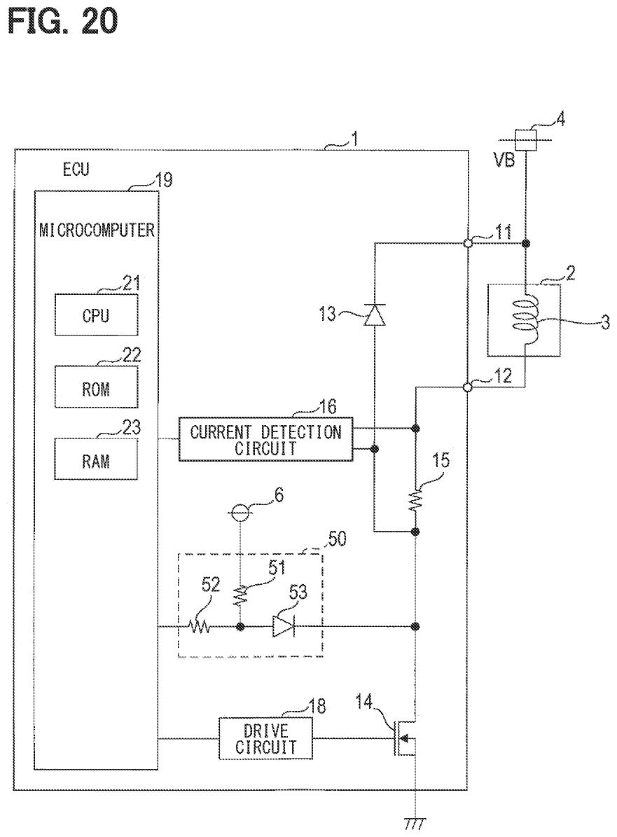

As illustrated in FIG. 20, the ECU 1 according to the eighth embodiment is different from the ECU 1 according to the fourth embodiment in that a terminal state detection circuit 50 is added and terminal failure detection processing is executed.

The terminal state detection circuit 50 includes resistors 51 and 52 and a diode 53. The resistor 51 has a first end connected to an internal power supply 6. The resistor 52 has a first end connected to the microcomputer 19. The resistors 51 and 52 have second ends connected to an anode of the diode 53. The diode 53 has a cathode connected to the second end of the shunt resistor 15.

In the terminal state detection circuit 50 configured as described above, when a voltage level of the negative terminal 12 is at a low level, a voltage level of a connection end with microcomputer 19 (that is, the first end of the resistor 52) is at a low level. When the voltage level of the negative terminal 12 is at a high level, the voltage level of the connection end with the microcomputer 19 is at a high level.

In other words, in the terminal state detection circuit 50, when the voltage level of the negative terminal 12 is at the low level, a terminal state detection signal for the voltage level to be the low level is output to microcomputer 19. In the terminal state detection circuit 50, when the voltage level of the negative terminal 12 is at the high level, a terminal state detection signal for the voltage level to be the high level is output to microcomputer 19.

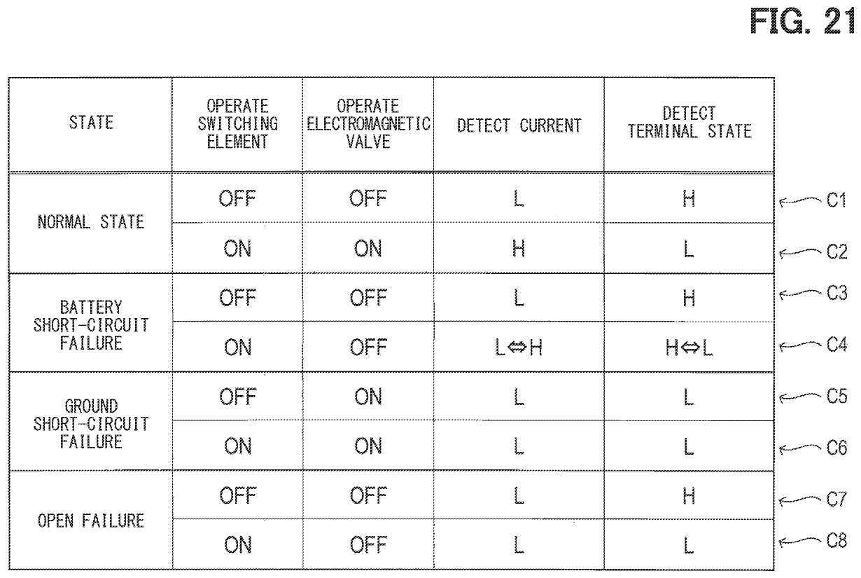

As illustrated in a first row C1 in FIG. 21, when the switching element 14 is in the off state in a case where the ECU 1 and the electromagnetic valve 2 are normal, the electromagnetic valve 2 is in the off state. Then, no current flows through the shunt resistor 15, and the voltage level of the negative terminal 12 turns into the high level. Thus, the current detection circuit 16 outputs a current detection signal for the voltage level to be the low level. The terminal state detection circuit 50 outputs a terminal state detection signal for the voltage level to be the high level.

As illustrated in a second row C2, when the switching element 14 is in the on state in a case where the ECU 1 and the electromagnetic valve 2 are normal, the electromagnetic valve 2 is in the on state. Then, a current flows through the shunt resistor 15, and the voltage level of the negative terminal 12 turns into the low level. Thus, the current detection circuit 16 outputs a current detection signal for the voltage level to be the high level. The terminal state detection circuit 50 outputs a terminal state detection signal for the voltage level to be the low level.

Further, as illustrated in a third row C3 and a fourth row C4, in a state in which a battery short-circuit failure in which the negative terminal 12 and the vehicle power supply 4 are short-circuited occurs, the electromagnetic valve 2 is in the off state regardless of whether the switching element 14 is in the off state or the on state.

Then, as illustrated in the third row C3, when the switching element 14 is in the off state, no current flows through the shunt resistor 15, and the voltage level of the negative terminal 12 is at the high level. Thus, the current detection circuit 16 outputs a current detection signal for the voltage level to be the low level.

The terminal state detection circuit 50 outputs a terminal state detection signal for the voltage level to be the high level.

When the switching element 14 is in the on state in a state where a battery short-circuit failure occurs in which the negative terminal 12 and the vehicle power supply 4 are short-circuited, a current flows through the shunt resistor 15, and the voltage level of the negative terminal 12 is at the low level. Thus, the current detection circuit 16 outputs a current detection signal for the voltage level to be the high level. The terminal state detection circuit 50 outputs a terminal state detection signal for the voltage level to be the low level.

Then, when an overcurrent flows through the shunt resistor 15, the switching element 14 enters the off state by an IPD built in the drive circuit 18. Thus, no current flows through the shunt resistor 15, and the voltage level of the negative terminal 12 turns into the high level. Thus, the current detection circuit 16 outputs a current detection signal for the voltage level to be the low level. The terminal state detection circuit 50 outputs a terminal state detection signal for the voltage level to be the high level. IPD stands for intelligent power device.

Thereafter, when the overcurrent of the shunt resistor 15 is eliminated, the switching element 14 returns to the on state. Then, when an overcurrent flows through the shunt resistor 15 again, the switching element 14 enters the off state by the IPD built in the drive circuit 18.

Therefore, as illustrated in the fourth row C4, when the switching element 14 is in the on state in a state where the battery short-circuit failure occurs, a state where the current detection signal is at the low level and the terminal state detection signal is at the high level and a state where the current detection signal is at the high level and the terminal state detection signal is at the low level are alternately repeated.

As illustrated in a fifth row C5 and a sixth row C6, in a state where a ground short-circuit failure in which the negative terminal 12 and the ground are short-circuited occurs, the electromagnetic valve 2 is in the on state whether the switching element 14 is in the off state or the on state. Then, whether the switching element 14 is in the off state or in the on state, no current flows through the shunt resistor 15, and the voltage level of the negative terminal 12 is at the low level. Thus, the current detection circuit 16 outputs a current detection signal for the voltage level to be the low level. The terminal state detection circuit 50 outputs a terminal state detection signal for the voltage level to be the low level.

As illustrated in a seventh row C7 and an eighth row C8, in a state where an open failure in which the negative terminal 12 is opened occurs, the electromagnetic valve 2 is in the off state whether the switching element 14 is in the off state or the on state.

Then, as illustrated in the seventh row C7, when the switching element 14 is in the off state, no current flows through the shunt resistor 15, and the voltage level of the negative terminal 12 is at the high level. Thus, the current detection circuit 16 outputs a current detection signal for the voltage level to be the low level.

The terminal state detection circuit 50 outputs a terminal state detection signal for the voltage level to be the high level.

Then, as illustrated in the eighth row C8, when the switching element 14 is in the on state, no current flows through the shunt resistor 15, and the voltage level of the negative terminal 12 is at the low level. Thus, the current detection circuit 16 outputs a current detection signal for the voltage level to be the low level. The terminal state detection circuit 50 outputs a terminal state detection signal for the voltage level to be the low level.

Next, a procedure of the terminal failure detection processing executed by the CPU 21 of the microcomputer 19 will be described. The terminal failure detection processing is processing repeatedly executed during the operation of the microcomputer 19.

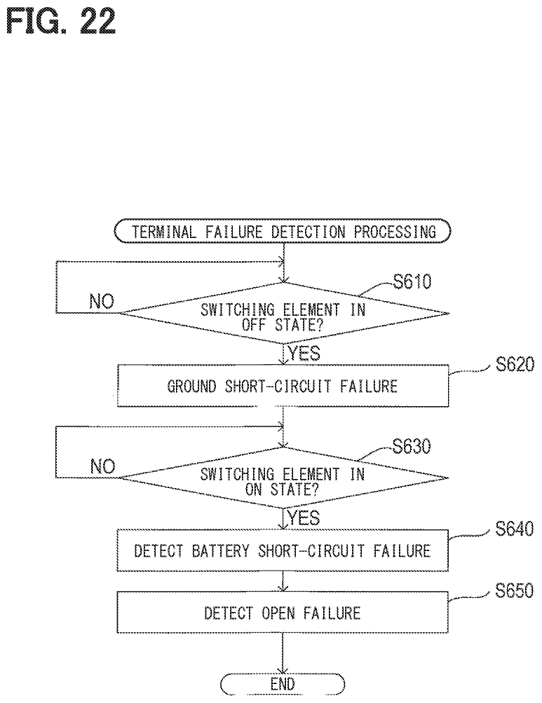

When the terminal failure detection processing is executed, as illustrated in FIG. 22, the CPU 21 first determines in S610 whether the switching element 14 is in the off state. Here, when the switching element 14 is not in the off state, the processing of S610 is repeated to stand by until the switching element 14 is in the off state.

Then, when the switching element 14 enters the off state, the CPU 21 detects a ground short-circuit failure in S620. Specifically, the CPU 21 determines whether the voltage level of the negative terminal 12 is at the low level on the basis of the terminal state detection signal. Here, when the voltage level of the negative terminal 12 is at the low level, the CPU 21 sets a ground short-circuit failure flag F11 provided in the RAM 23. Here, when the voltage level of the negative terminal 12 is at the high level, the CPU 21 clears the ground short-circuit failure flag F11.

When the processing of S620 ends, the CPU 21 determines in S630 whether the switching element 14 is in the on state. Here, when the switching element 14 is not in the on state, the processing of S630 is repeated to stand by until the switching element 14 is in the on state.

Then, when the switching element 14 enters the on state, the CPU 21 detects a battery short-circuit failure in S640. Specifically, on the basis of the terminal state detection signal, the CPU 21 determines whether the voltage level of the negative terminal 12 is repeatedly switched between the high level and the low level. Here, when the voltage level of the negative terminal 12 is repeatedly switched between the high level and the low level, the CPU 21 sets a battery short-circuit failure flag F12 provided in the RAM 23. On the other hand, when the voltage level of the negative terminal 12 is not repeatedly switched between the high level and the low level, the CPU 21 clears the battery short-circuit failure flag F12.

When the processing of S640 ends, the CPU 21 detects an open failure in S650, and ends the terminal failure detection processing. Specifically, the CPU 21 determines whether a current is flowing through the shunt resistor 15 on the basis of the current detection signal. Here, when no current is flowing through the shunt resistor 15, the CPU 21 sets an open failure flag F13 provided in the RAM 23. Here, when a current is flowing through the shunt resistor 15, the CPU 21 dears the open failure flag F13.

The ECU 1 configured as described above includes the positive terminal 11 the negative terminal 12, and the terminal state detection circuit 50.

The positive terminal 11 is connected to a first end of the electromagnetic valve 2, the first end being an end connected to the vehicle power supply 4 that applies the power supply voltage VB to the electromagnetic valve 2. The negative terminal 12 is connected to a second end of the electromagnetic valve 2, the second end being an end connected to the ground.

The terminal state detection circuit 50 includes the resistor 51 and the diode 53, and detects the voltage level at the negative terminal 12.

The shunt resistor 15 and the current detection circuit 16 detect a regenerative current flowing through the energization path between the negative terminal 12 and the diode 13.

The microcomputer 19 detects a ground short-circuit failure in the negative terminal 12 on the basis of a detection result of the terminal state detection circuit 50 when the application of the power supply voltage to the electromagnetic valve 2 is stopped.

The microcomputer 19 detects a battery short-circuit failure in the negative terminal 12 on the basis of the detection result of the terminal state detection circuit 50 while power is supplied to the electromagnetic valve 2.

The microcomputer 19 detects an open failure in the negative terminal 12 on the basis of the detection result of the terminal state detection circuit 50 while power is supplied to the electromagnetic valve 2.

The ECU 1 as described above enables to detect a ground short-circuit failure, a battery short-circuit failure, and an open failure at the negative terminal 12.

In the embodiment described above, the terminal state detection circuit 50 correspods to a terminal state detector, the resistor 51 corresponds to a pull-up resistor, S620 corresponds to processing as a ground short-circuit failure detector, S640 corresponds to processing as a battery short-circuit failure detector, and S650 corresponds to processing as a first open failure detector.

### Ninth Embodiment

Hereinafter, a ninth embodiment of the present disclosure will be described with reference to the drawings. In the ninth embodiment, differences from the sixth embodiment will be described. Common configurations are denoted by the same reference numerals.

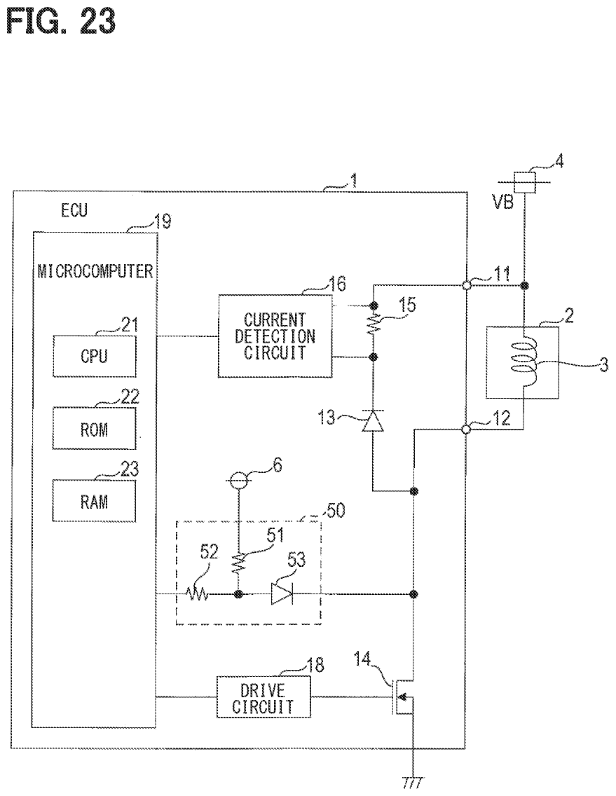

As illustrated in FIG. 23, the ECU 1 according to the ninth embodiment is different from the ECU 1 according to the sixth embodiment in that the terminal state detection circuit 50 is added and the terminal failure detection processing is executed.

Since the terminal state detection circuit 50 of the ninth embodiment is the same as the terminal state detection circuit 50 according to the eighth embodiment, the description thereof will be omitted.

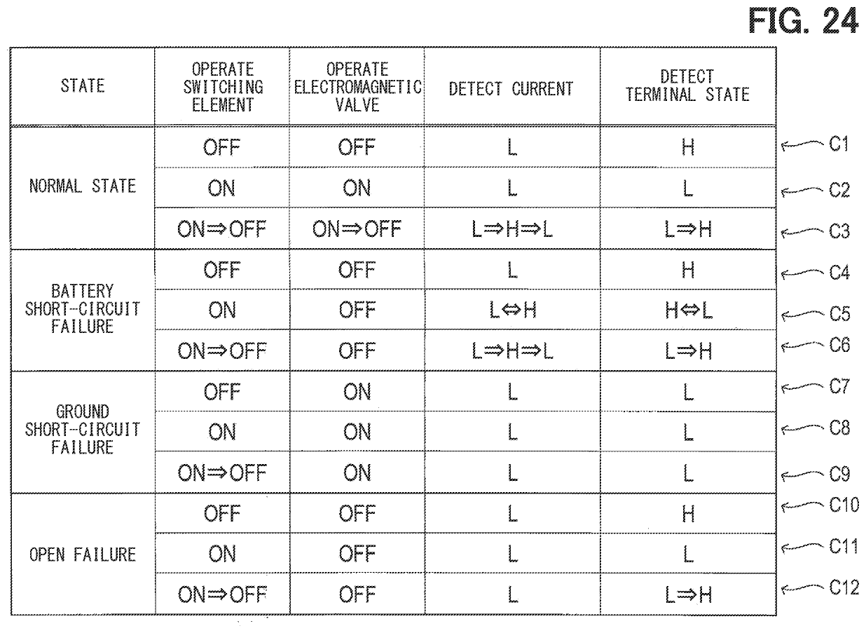

As illustrated in FIGS. 21 and 24, a first row C1 and a second row C2 in FIG. 24 are the same as the first row C1 and the second row C2 in FIG. 21, respectively. A fourth row C4 and a fifth row C5 in FIG. 24 are the same as the third row C3 and the fourth row C4 in FIG. 21, respectively. A seventh row C7 and an eighth row C8 in FIG. 24 are the same as the fifth row C5 and the sixth row C6 in FIG. 21, respectively. A tenth row C10 and an eleventh row C11 in FIG. 24 are the same as the seventh row C7 and the eighth row C8 in FIG. 21, respectively. Therefore, descriptions of the first row C1, the second row C2, the fourth row C4, the fifth row C5, the seventh row C7, the eighth row C8, the tenth row C10, and the eleventh row C11 in FIG. 24 are omitted.

As illustrated in the third row C3 in FIG. 24, when the switching element 14 is switched from the on state to the off state in a case where the ECU 1 and the electromagnetic valve 2 are normal, the electromagnetic valve 2 is switched to the off state. Thus, a current flows through the shunt resistor 15 only for a short time, and the voltage level of the negative terminal 12 turns from the low level to the high level. Therefore, the current detection signal output from current detection circuit 16 changes from the low level to the high level only for a short time, and returns to the low level again. The terminal state detection signal output from the terminal state detection circuit 50 changes from the low level to the high level.

As illustrated in the sixth row C6 in FIG. 24, when the switching element 14 is switched from the on state to the off state in a state where a battery short-circuit failure occurs, the electromagnetic valve 2 remains in the off state. At this time, as in the normal time, a current flows through the shunt resistor 15 only for a short time, and the voltage level of the negative terminal 12 turns from the low level to the high level. Therefore, the current detection signal output from current detection circuit 16 changes from the low level to the high level only for a short time, and returns to the low level again. The terminal state detection signal output from the terminal state detection circuit 50 changes from the low level to the high level.

As illustrated in the ninth row C9 in FIG. 24, when the switching element 14 is switched from the on state to the off state in a case where a ground short-circuit failure occurs, the electromagnetic valve 2 remains in the on state. At this time, no current flows through the shunt resistor 15, and the voltage level of the negative terminal 12 remains in the low level. Thus, the current detection circuit 16 outputs a current detection signal for the voltage level to be the low level. The terminal state detection circuit 50 outputs a terminal state detection signal for the voltage level to be the low level.

As illustrated in a twelfth row C12 in FIG. 24, when the switching element 14 is switched from the on state to the off state in a state where an open failure occurs, the electromagnetic valve 2 remains in the off state. At this time, no current flows through the shunt resistor 15, and the voltage level of the negative terminal 12 turns from the low level to the high level. Thus, the current detection signal output from the current detection circuit 16 remains in the low level. The terminal state detection signal output from the terminal state detection circuit 50 changes from the low level to the high level.

Next, a procedure of the terminal failure detection processing executed by the CPU 21 of the microcomputer 19 will be described.

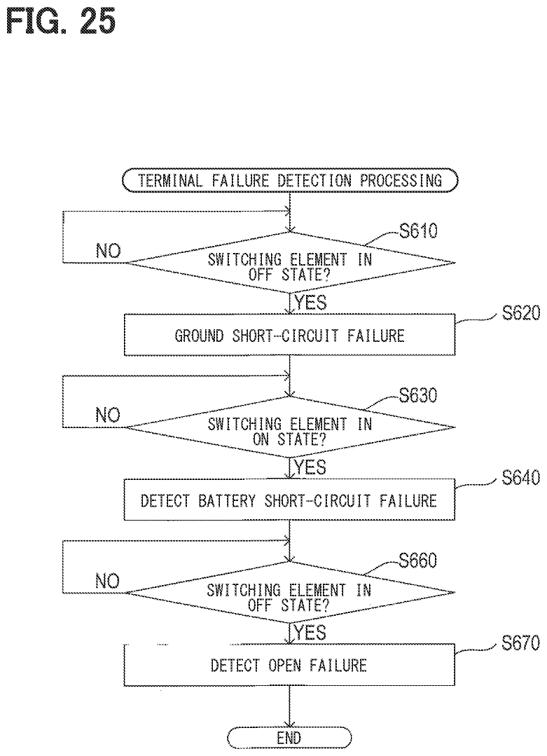

As illustrated in FIG. 25, the terminal failure detection processing according to the ninth embodiment is different from the terminal failure detection processing according to the eighth embodiment in that the processing of S650 is omitted and the processing of S660 and S670 are added.

That is, when the processing of S640 ends, the CPU 21 determines in S660 whether the switching element 14 is in the off state, Here, when the switching element 14 is not in the off state, the processing of S660 is repeated to stand by until the switching element 14 is in the off state.

When the switching element 14 enters the off state, the CPU 21 detects an open failure in S670, and ends the terminal failure detection processing. Specifically, the CPU 21 determines whether a current flows through the shunt resistor 15 on the basis of the current detection signal. Here, when no current flows through the shunt resistor 15, the CPU 21 sets the open failure flag F13. On the other hand, when a current flows through the shunt resistor 15, the CPU 21 clears the open failure flag F13.

The ECU 1 configured as described above includes the positive terminal 11, the negative terminal 12, and the terminal state detection circuit 50.

The microcomputer 19 detects a ground short-circuit failure in the negative terminal 12 on the basis of a detection result of the terminal state detection circuit 50 when the application of the power supply voltage to the electromagnetic valve 2 is stopped.

The microcomputer 19 detects a battery short-circuit failure in the negative terminal 12 on the basis of the detection result of the terminal state detection circuit 50 while power is supplied to the electromagnetic valve 2.

The microcomputer 19 detects an open failure in the negative terminal 12 on the basis of the detection result of the terminal state detection circuit 50 immediately after the application of the power supply voltage to the electromagnetic valve 2 is stopped.

The ECU 1 as described above enables to detect a ground short-circuit failure, a battery short-circuit failure, and an open failure at the negative terminal 12.

In the embodiment described above, S670 corresponds to processing as a second open failure detector.

Although one embodiment of the present disclosure has been described above, the present disclosure is not limited to the embodiment, and various modifications can be made.

### First Modification

For example, the above embodiment has shown a mode in which a point at which the electromagnetic valve current value changes from decrease to increase in the temporal change of the electromagnetic valve current is detected as an electromagnetic valve current singularity. However, the electromagnetic valve current singularity may be any point as long as a transition between the closed valve state and the open valve state in the electromagnetic valve 2 can be identified. For example, the electromagnetic valve current singularity may be a point at which the electromagnetic valve current value changes from increase to decrease, or may be a point at which a decrease gradient changes rapidly.

### Second Modification

The above embodiment has shown a mode in which a point at which the regenerative current value changes from increase to decrease in the temporal change of the regenerative current is detected as a regenerative current singularity. However, the regenerative current singularity may be any point as long as a transition between the closed valve state and the open valve state in the electromagnetic valve 2 can be identified. For example, the regenerative current singularity may be a point at which the regenerative current value changes from decrease to increase, or may be a point at which an increase gradient changes rapidly.

The microcomputer 19 and a method thereof described in the present disclosure may be achieved by a dedicated computer provided by configuring a processor and a memory programmed to execute one or a plurality of functions embodied by a computer program. Alternatively, the microcomputer 19 and the method thereof described in the present disclosure may be achieved by a dedicated computer provided by configuring a processor with one or more dedicated hardware logic circuits. Alternatively, the microcomputer 19 and the method thereof described in the present disclosure may be achieved by one or more dedicated computers configured by a combination of a processor and a memory programmed to execute one or a plurality of functions and a processor configured by one or more hardware logic circuits.

The computer program may be stored in a computer-readable non-transitory tangible recording medium as an instruction executed by a computer. The method of achieving functions of parts included in the microcomputer 19 does not need to include software, and all the functions may be achieved by using one or a plurality of pieces of hardware.

A plurality of functions of one component in the embodiment may be achieved by a plurality of components, or one function of one component may be achieved by a plurality of components. A plurality of functions of a plurality of components may be achieved by one component, or one function achieved by a plurality of components may be achieved by one component. A part of the configuration of the embodiment may be omitted. At least a part of the configuration of the embodiment may be added to or replaced with another configuration of the embodiment.

In addition to the ECU 1 described above, the present disclosure can be achieved in various forms such as a system including the ECU 1 as a component, a program for causing a computer to function as the ECU 1, a non-transitory tangible recording medium such as a semiconductor memory storing the program, and a failure detection method.

What is claimed is:

1. An electronic control device configured to control at least one electromagnetic valve mounted on a vehicle, the electronic control device comprising:
a regenerative current detector configured to detect a regenerative current circulating through the at least one electromagnetic valve immediately after power supply to the at least one electromagnetic valve is stopped;
a regenerative current singularity detector configured to detect a regenerative current singularity that is a singularity in a temporal change of the regenerative current; and
a regenerative current failure detector configured to detect a stuck failure of the at least one electromagnetic valve based on a detection result of the regenerative current singularity detector.

2. The electronic control device according to claim 1, further comprising:
a freewheeling diode configured to conduct the regenerative current.

3. The electronic control device according to claim 2, wherein
the regenerative current detector is configured to detect the regenerative current flowing through an energization path between the freewheeling diode and a direct-current power supply, which is configured to apply a power supply voltage to the at least one electromagnetic valve.

4. The electronic control device according to claim 1, wherein
the at least one electromagnetic valve includes a plurality of electromagnetic valves, and
the regenerative current detector is configured to detect the regenerative current of each of the plurality of electromagnetic valves.

5. The electronic control device according to claim 2, wherein
the at least one electromagnetic valve has a first end, which is connected to a direct-current power supply that is configured to apply a power supply voltage to the at least one electromagnetic valve, and a second end, which is connected to a ground,
the electronic control device further comprising:
a positive terminal connected to the first end;
a negative terminal connected to the second end; and
a terminal state detector including a pull-up resistor and a diode and configured to detect a voltage level at the negative terminal, wherein
the regenerative current detector is configured to detect the regenerative current flowing through an energization path between the negative terminal and the freewheeling diode, and
the electronic control device further comprising:
a ground short-circuit failure detector configured to detect a ground short-circuit failure at the negative terminal based on a detection result of the terminal state detector when application of the power supply voltage to the at least one electromagnetic valve is stopped;
a battery short-circuit failure detector configured to detect a battery short-circuit failure at the negative terminal based on a detection result of the terminal state detector when the power supply voltage is applied to the at least one electromagnetic valve; and
a first open failure detector configured to detect an open failure at the negative terminal based on a detection result of the regenerative current detector when the power supply is supplied to the at least one electromagnetic valve.

6. The electronic control device according to claim 3, wherein
the at least one electromagnetic valve has a first end, which is connected to a direct-current power supply that is configured to apply the power supply voltage to the at least one electromagnetic valve, and a second end, which is connected to a ground, and
the electronic control device further comprising:
a positive terminal connected to the first end;
a negative terminal connected to the second end;
a terminal state detector that includes a pull-up resistor and a diode and configured to detect a voltage level at the negative terminal;
a ground short-circuit failure detector configured to detect a ground short-circuit failure at the negative terminal based on a detection result of the terminal state detector when application of the power supply voltage to the at least one electromagnetic valve is stopped;
a battery short-circuit failure detector configured to detect a battery short-circuit failure at the negative terminal based on a detection result of the terminal state detector when the power supply voltage is applied to the at least one electromagnetic valve; and
a second open failure detector configured to detect an open failure at the negative terminal based on a detection result of the regenerative current detector immediately after the application of the power supply voltage to the at least one electromagnetic valve is stopped.

7. An electronic control device configured to control at least one electromagnetic valve mounted on a vehicle, the electronic control device comprising:
an electromagnetic valve current detector configured to detect an electromagnetic valve current flowing through the at least one electromagnetic valve after power supply to the at least one electromagnetic valve is started;
a power supply voltage detector configured to detect a power supply voltage of a direct-current power supply that is configured to apply the power supply voltage to the at least one electromagnetic valve;
an electromagnetic valve current singularity detector configured to detect an electromagnetic valve current singularity that is a singularity in a temporal change of the electromagnetic valve current;
an electromagnetic valve current failure detector configured to detect a stuck failure of the at least one electromagnetic valve based on a detection result of the electromagnetic valve current singularity detector; and
a failure detection inhibitor configured to
determine whether a fluctuation in the power supply voltage has occurred based on a detection result of the power supply voltage detector and
on determination that the fluctuation in the power supply voltage has occurred, inhibit the electromagnetic valve current failure detector from detecting the stuck failure until a preset inhibition release condition is satisfied.

8. The electronic control device according to claim 7, wherein
the inhibition release condition includes a condition in which the electromagnetic valve current becomes 0.

9. The electronic control device according to claim 7, wherein
the inhibition release condition includes a condition in which a preset inhibition time elapses after the fluctuation in the power supply voltage occurs.

10. An electronic control device configured to control at least one electromagnetic valve mounted on a vehicle, the electronic control device comprising:
an electromagnetic valve current detector configured to detect an electromagnetic valve current flowing through the at least one electromagnetic valve after power supply to the at least one electromagnetic valve is started;
a power supply voltage detector configured to detect a power supply voltage of a direct-current power supply, which is configured to apply the power supply voltage to the at least one electromagnetic valve;
an electromagnetic valve current singularity detector configured to detect an electromagnetic valve current singularity that is a singularity in a temporal change of the electromagnetic valve current;
an electromagnetic valve current failure detector configured to detect a stuck failure of the at least one electromagnetic valve based on a detection result of the electromagnetic valve current singularity detector; and
an invalidator configured to
determine whether a fluctuation in the power supply voltage has occurred based on a detection result of the power supply voltage detector and
on determination that the fluctuation in the power supply voltage has occurred, invalidate at least a detection result of the electromagnetic valve current singularity detector corresponding to a time point at which the fluctuation in the power supply voltage occurs.

11. The electronic control device according to claim 7, further comprising:
a regenerative current detector configured to detect a regenerative current circulating through the at least one electromagnetic valve immediately after the power supply to the at least one electromagnetic valve is stopped;
a regenerative current singularity detector configured to detect a regenerative current singularity that is a singularity in a temporal change of the regenerative current; and
a regenerative current failure detector configured to detect a stuck failure of the at least one electromagnetic valve based on a detection result of the regenerative current singularity detector.
